(19) United States
(12) Patent Application Publication
(10) Pub. No.: US 2026/0157567 A1
(43) Pub. Date: Jun. 11, 2026

(54) FOOD HOLDING SYSTEM

(71) Applicant: CFA Properties, Inc., Atlanta, GA (US)

(72) Inventors: Travis Mills, St. Louis, MO (US); Austin Newland, St. Louis, MO (US); Andy Wu, Atlanta, GA (US)

(21) Appl. No.: 19/101,497

(22) PCT Filed: Aug. 30, 2024
(86) PCT No.: PCT/US2024/044606

§ 371 Date: Feb. 5, 2025

Related U.S. Application Data
(60) Provisional application No. 63/579,593, filed on Aug. 30, 2023.
(60) Provisional application No. 63/579,625, filed on Aug. 30, 2023.
(60) Provisional application No. 63/579,609, filed on Aug. 30, 2023.
(60) Provisional application No. 63/579,573, filed on Aug. 30, 2023.

(51) Int. Cl. A47J 36/24; F24C 15/32

(52) U.S. Cl. CPC A47J 36/2483; F24C 15/32

(57) ABSTRACT

A food holding system, components thereof, and associated methods. The system includes a food holder and a food holding unit. The food holder has a food holding space for receiving the cooked food. The food holding unit includes a cabinet having a food holder space that receives the food holder. The food holder space has an open front in open communication with a surrounding environment. The open front permits the food holder to be inserted into and removed from the food holder space. Ductwork extends along the first side of the cabinet. The ductwork includes an outlet arranged to direct gas into the food holder when the food holder is received in the food holder space. A heating element is disposed in the ductwork for heating gas. A blower moves the gas in the ductwork through the outlet and toward the food holder.

### CROSS-REFERENCE TO RELATED APPLICATIONS

This application claims the benefit of U.S. Provisional Application No. 63/579,593, filed Aug. 30, 2023, the benefit of U.S. Provisional Application No. 63/579,573, filed Aug. 30, 2023, the benefit of U.S. Provisional Application No. 63/579,609, filed Aug. 30, 2023, the benefit of U.S. Provisional Application No. 63/579,654, filed Aug. 30, 2023, and the benefit of U.S. Provisional Application No. 63/579,625, filed Aug. 30, 2023, the entireties of which are hereby incorporated by reference.

### FIELD

The present disclosure generally relates to food preparation equipment, and more particularly to food holding equipment.

### BACKGROUND

This disclosure is directed to food holding equipment that uses hot gas to maintain pre-cooked food at proper temperatures before the food is served for consumption. This type of equipment is also often referred to as a food warmer. Such equipment is used in the quick service food service industry to heat food or maintain cooked food at a desired temperature prior to the food being served.

### SUMMARY

In one aspect, a food holding system comprises a food holder and a food holding unit. The food holder includes a bottom wall and a first upstanding wall. The food holder includes a food support surface above the bottom wall. The food support surface has openings therein. The food support surface bounds a food holding space. The food holder defines a gas passageway between the food holding space and the first upstanding wall and defines a gas supply plenum between the food holding space and the bottom wall. The gas supply plenum is in fluid communication with the gas passageway. The food holding space is in fluid communication with the gas supply plenum via the openings in the food support surface. The food holding unit defines a food holder space sized and shaped to receive the food holder. The food holder space has a food holder opening sized and shaped to permit the food holder to be inserted into and removed from the food holder space through the food holder opening. The food holder space is in open communication with a surrounding environment outside the food holding unit via the food holder opening. The food holding unit includes a heated gas delivery system including a heated gas outlet configured to emit heated gas into the food holder space. The heated gas outlet is configured to, when the food holder is in the food holder space, direct heated gas from the heated gas outlet to flow downward in the gas passageway of the food holder to the gas supply plenum to move upward through the openings of the food support surface into the food holding space to heat food therein.

In another aspect, a method of holding food comprises placing food in a food holding space of a food holder; installing the food holder in a food holder space of a food holding unit; operating a heated gas delivery system of the food holding unit to heat gas and to direct the heated gas downward from a first heated gas outlet of the food holding unit into a first gas passage of the food holder; permitting the heated gas to flow downward along the first gas passage between the food holding space and a first upstanding wall of the food holder; after permitting the heated gas to flow downward along the first gas passage, permitting the heated gas to flow in a gas supply plenum underlying the food holding space; and after permitting the heated gas to flow in the gas supply plenum, permitting the heated gas to flow upward into the food holding space to heat the food in the food holding space.

In another aspect, a food holder for use with a food holding unit comprises a food container comprising a bottom wall and a first upstanding wall. The bottom wall and the first upstanding wall bound a food container interior. A food support body is configured to be removably receivable in the food container interior. The food support body comprises a floor and a first side wall. The floor and the first side wall bound a food holding space. The floor defines a food support surface for supporting food in the food holding space. The food support surface includes a plurality of gas flow openings. A first spacer is configured to cause the first side wall to be spaced from the first upstanding wall when the food support body is in the food container interior to define a first gas passageway between the first side wall and the first upstanding wall. A second spacer is configured to cause the floor to be spaced from the bottom wall when the food support body is in the food container interior to define a gas supply plenum between the floor and the bottom wall. When the food support is in the food container interior, the gas passageway is in fluid communication with the gas supply plenum, and the gas supply plenum is in fluid communication with the food holding space via the plurality of openings in the food support surface.

In another aspect, a food holding unit for maintaining cooked food held by a food holder at a proper temperature comprises a cabinet having a front and a back. The cabinet has opposite first and second sides. The cabinet has a food holder space sized and shaped to receive the food holder containing the cooked food. The food holder space has an open front in open communication with a surrounding environment outside the food holding unit. The open front is sized and shaped to permit the food holder to be inserted into and removed from the food holder space through the open front. The cabinet has a gas inlet in fluid communication with the food holder space. Ductwork extends along the first side of the cabinet. The ductwork includes an outlet arranged to direct gas into the food holder space. A heating element is disposed in the ductwork for heating gas in the ductwork. A blower is disposed at an elevation above the outlet. The blower is configured to draw gas from the food holder space through the gas inlet and move the gas through the ductwork, through the outlet, and back into the food holder space.

In another aspect, a food holding unit for maintaining cooked food held by a food holder at a proper temperature comprises a cabinet having a front and a back. The cabinet has opposite first and second sides. The cabinet has a food holder space sized and shaped to receive the food holder containing the cooked food. The food holder space has an open front in open communication with a surrounding environment outside the food holding unit. The open front is sized and shaped to permit the food holder to be inserted into and removed from the food holder space through the open front. Ductwork extends along the first side of the cabinet. The ductwork includes an outlet arranged to direct gas downward into the food holder space. A heating element is disposed in the ductwork for heating gas in the ductwork. A blower is disposed at an elevation above the outlet. The blower is configured to emit gas from the blower downward to move gas in the ductwork through the outlet and into the food holder space.

Other objects and features will be in part apparent and in part pointed out hereinafter.

### BRIEF DESCRIPTION OF THE DRAWINGS

FIG. 1 is a perspective of a food holding unit according to one embodiment of the present disclosure;

FIG. 2 is another perspective of the food holding unit;

FIG. 3 is a front elevation of the food holding unit;

FIG. 4 is a cross-section of the food holding unit;

FIG. 5 is a fragmentary, enlarged portion of the cross-section of FIG. 4;

FIG. 6 is a fragmentary, enlarged portion of the cross-section of FIG. 5;

FIG. 7 is a cross-sectional perspective of the food holding unit, with portions of the food holding unit shown transparent to show interior details;

FIG. 8 is a perspective of a food holding unit according to another embodiment of the present disclosure;

FIG. 9 is another perspective of the food holding unit of FIG. 8;

FIG. 10 is a front elevation of the food holding unit of FIG. 8;

FIG. 11 is a cross-section of the food holding unit of FIG. 8;

FIG. 12 is a fragmentary, enlarged portion of the cross-section of FIG. 11;

FIG. 13 is a cross-sectional perspective of the food holding unit of FIG. 8, with portions of the food holding unit shown transparent to show interior details;

FIG. 14 is a front perspective of a food holding unit according to another embodiment of the present disclosure;

FIG. 15 is a rear perspective of the food holding unit of FIG. 14;

FIG. 16 is a front elevation of the food holding unit of FIG. 14;

FIG. 17 is a vertical cross-section of the food holding unit of FIG. 14;

FIG. 18 is a fragmentary, enlarged portion of the cross-section of FIG. 17;

FIG. 19 is a cross-sectional perspective of the food holding unit of FIG. 14, with portions of the food holding unit shown transparent to show interior details;

FIG. 20 is a perspective of a food holding unit of FIG. 14, with removable duct sections of the food holding unit removed;

FIG. 21 is a vertical cross-section of the food holding unit of FIG. 20;

FIG. 22 is a horizontal cross-section of the food holding unit of FIG. 14;

FIG. 23 is a perspective of one embodiment of a food holding assembly with two food holding units of FIG. 14;

FIG. 24 is a perspective of another embodiment of a food holding assembly with four food holding units of FIG. 14;

FIG. 25 is a perspective of a food holder according to one embodiment of the present disclosure;

FIG. 26 is an exploded perspective of the food holder;

FIG. 27 is a perspective of a food support of the food holder;

FIG. 28 is a lengthwise cross-section of the food holder;

FIG. 29 is a widthwise cross-section of the food holder;

FIG. 30 is a perspective of the food holding unit of FIG. 14 with the food holder of FIG. 25; and

FIG. 31 is a vertical cross-section of the food holding unit and food holder of FIG. 30.

Corresponding reference characters indicate corresponding parts throughout the drawings.

### DETAILED DESCRIPTION

The present disclosure relates to a food holding unit (e.g., a holding oven, a food warmer), and associated food holder, that uses hot gas or air to maintain cooked food at a proper temperature before the food is served for consumption. The food holding units shown and described herein can be used to heat or keep warm various types of food, such as fried foods (e.g., potato fries, onion rings, chicken, etc.) and non-fried foods, for serving after the food has been cooked. The food holder holds and supports the food in the food holding unit. The food holding unit supplies heated gas (e.g., air) to the food holder to heat or keep warm various types of food (e.g., cooked food), such as fried foods (e.g., potato fries, onion rings, chicken, etc.) and non-fried foods, contained by the food holder. Collectively, the food holding unit and the food holder form a food holding system (broadly, a food holding system includes one or more food holding units and one or more food holders).

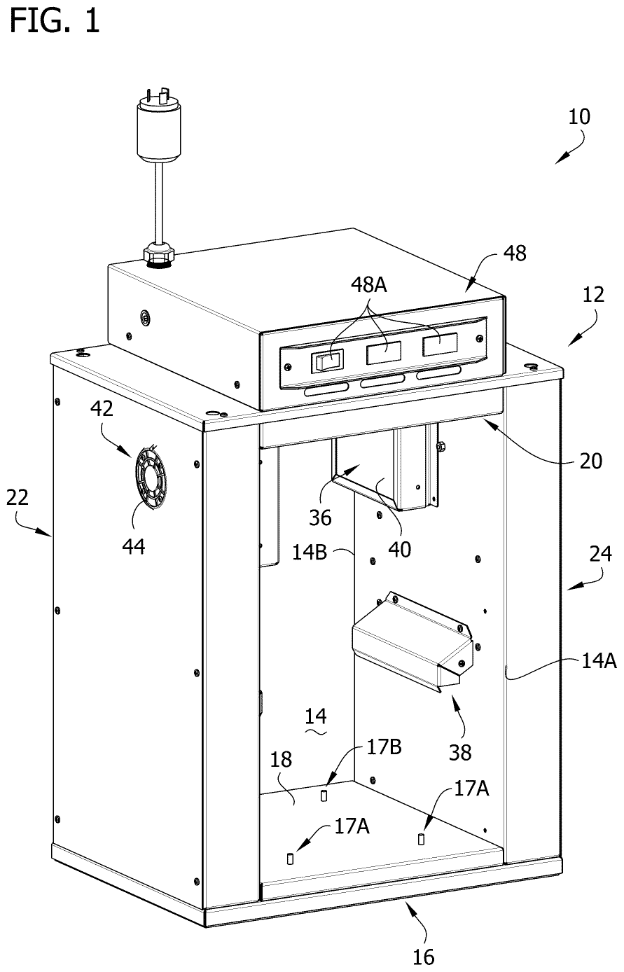

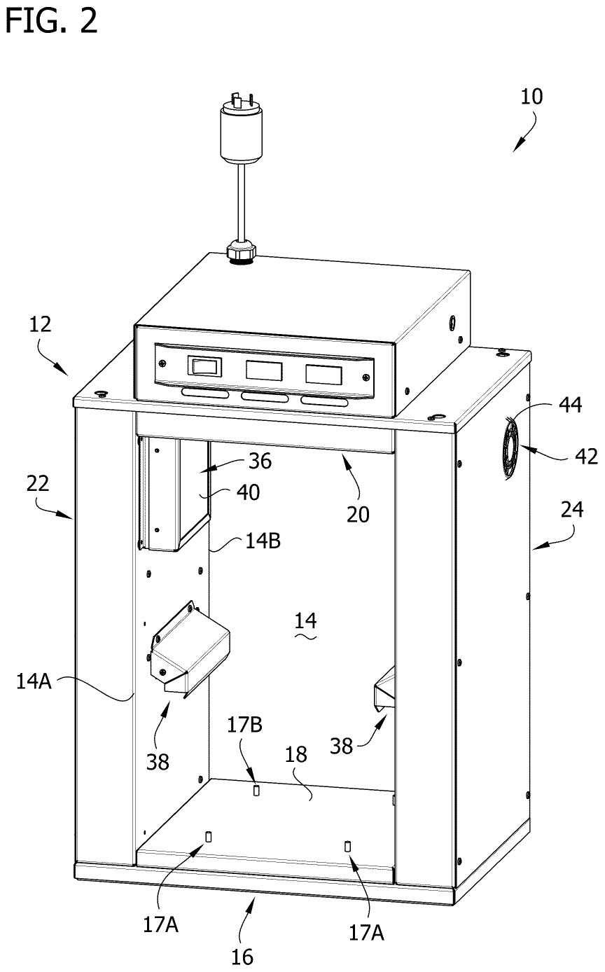

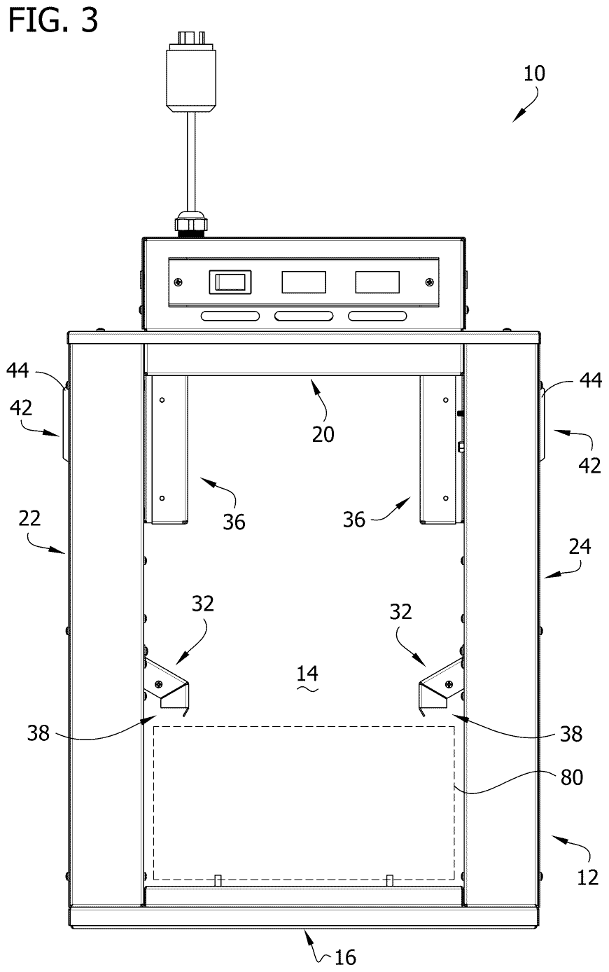

Referring to FIGS. 1-7, a food holding unit according to one embodiment of the present disclosure is generally indicated by reference numeral 10. The food holding unit 10 maintains cooked food at a proper temperature. The cooked food may be held by a food holder (shown schematically at reference numeral 80) that is in the food holding unit 10. The food holding unit 10 is configured for heating food with heated gas (e.g., air). For example, the food holding unit 10 may be referred to as a food warmer for maintaining cooked food held by the food holder 80 in a warm condition (broadly, proper serving temperature) before it is served. The food holding unit 10 may be used for heating various types of food, such as potato fries, onion rings, and other fried foods or non-fried foods.

The food holding unit 10 includes a cabinet, generally indicated at 12. The cabinet 12 has a front and a back and opposite first and second sides. The cabinet 12 has (e.g., defines) a food holder space or interior 14 (broadly, food conditioning space or food holding space) that is sized and shaped to receive the food holder 80 (broadly, one or more food holders) containing the cooked food (broadly, the food holder space is sized and shaped to receive the food). The food holder space 14 of the cabinet 12 has an open front 14A. The open front 14A is in open communication (e.g., direct open fluid communication) with the surrounding environment outside the food holding unit 10. The open front 14A is sized and shaped to permit the food holder 80 to be inserted into and removed from the food holder space 14 through the open front and for a user to remove food from the holder while the holder is in the food holder space.

Desirably, the cabinet 12 is a pass-through cabinet. In the illustrated embodiment, the food holder space 14 of the cabinet 12 also has an open back 14B opposite the open front 14A. The open back 14B is in open communication (e.g., direct open communication) with the surrounding environment outside the food holding unit 10. The open back 14B is sized and shaped to permit the food holder 80 to be inserted into and removed from the food holder space 14 through the open back and for a user to remove food from the holder while the holder is in the food holder space. The open front 14A and the open back 14B of the food holder space 14 allow the food holder 80 to be inserted into and removed from the food holder space of the cabinet 12 from the front and/or back and allow food to be inserted into and removed from the food holder from the front and/or back.

The cabinet 12 has a base 16 which includes a floor 18. The base 16 rests on a support surface, such as a countertop or tabletop. The floor 18 supports the food holder 80 when the food holder is disposed in the food holder space 14 of the cabinet 12. The removability of the food holder 80 makes it easier to (1) place and remove food from the food holder and (2) to clean the food holder (e.g., remove grease, food, and/or other debris). The floor 18 can be broadly referred to as a food holder support.

The food holding unit 10 is free of a door (e.g., front door) arranged to close the open front 14A of the food holder space 14 and is free of a door (e.g., back door) arranged to close the open back 14B of the food holder space. The absence of doors allows an operator or user to quickly insert the food holder 80 into and remove the food holder from the food holder space 14. Broadly, the food holding unit 10 is free of any structure that would need to be moved, either manually or automatically, to allow the food holder 80 to be inserted into and/or removed from the food holder space 14.

The floor 18 of the cabinet 12 bounds a bottom of the food holder space 14. Desirably, the floor 18 extends from the front to the back of the cabinet 12. The cabinet 12 includes a ceiling or top portion 20 that bounds a top of the food holder space 14. The cabinet 12 also includes a first side and a second side. The cabinet 12 includes opposite first and second side walls (e.g., left and right side walls) 22, 24 generally forming the respective first and second sides of the cabinet. The first side wall 22 bounds a first side of the food holder space 14 and the second side wall 24 bounds a second side of the food holder space. Desirably, the open front 14A and the open back 14B extend from the floor 18 to the ceiling 20 and from the first side wall 22 to the second side wall 24. This makes the open front 14A and open back 14B relatively large. The large size of the open front 14A and the open back 14B relative to the food holder 80 makes it easier to insert and remove the food holder into and from the food holder space 14 and to retrieve food while the holder is in the space. The base 16 is arranged to support the food (specifically, the food holder 80) between the first and second side walls 22, 24. In the illustrated embodiment, the base 16 includes one or more rear stops 17B and one or more front stops 17A for positioning the food holder 80 in the food holder space 14 (such as relative to the outlets 38 described herein). In the illustrated embodiment, the front and rear stops 17A-B comprise projections or pegs extending upward from the floor 18, although other configurations may be used without departing from the scope of the present disclosure.

The food holding unit 10 includes a forced air heating system (broadly, heated gas delivery system) for heating and moving gas about the cabinet 12. The forced air heating system moves the heated gas toward the food to be heated, thereby maintaining the cooked food at a proper temperature before serving. The forced air heating system includes one or more outlets (e.g., gas outlets) 38. In the illustrated embodiment, the forced air heating system includes two outlets 38. The outlets 38 deliver or direct the heated gas into the food holder space 14. Specifically, the outlets 28 are arranged to direct the gas into the food holder 80. The two outlets 38 are disposed on opposite sides of the food holder space 14. In the illustrated embodiment, the outlets 38 are arranged to deliver or direct the heated gas in a downward (e.g., generally vertically downward direction) into the food holder space 14. In one embodiment, the width of the food holder space 14 (e.g., the distance between the first and second side walls 22, 24) is slightly greater (e.g., less than 2 inches greater, or less than 1 inch greater) than a corresponding width of the food holder 80. This facilitates the locating of the food holder 80 laterally (e.g., side-to-side) in the food holder space 14. In particular, this facilitates the positioning of the food holder 80 relative to the outlets 38. In one embodiment, each outlet 38 is arranged to generally align with an inlet of the food holder 80 to direct the heated air toward and into the inlet of the food holder.

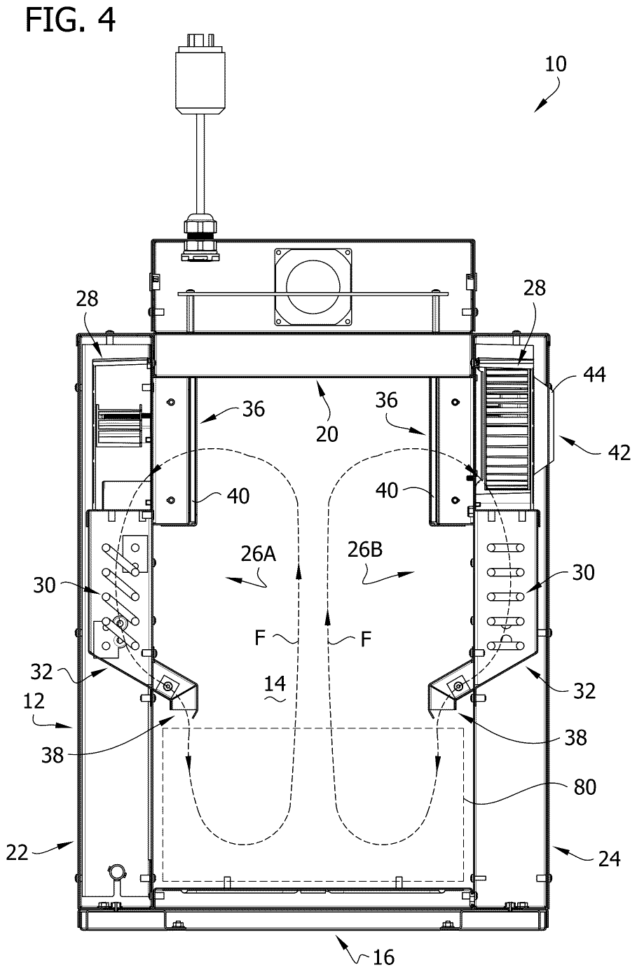

With reference to FIGS. 4-7, the forced air heating system includes a first (left) forced air heating sub-system 26A and a second (right) forced air heating sub-system 26B. The first forced air heating sub-system 26A is supported by and is generally disposed in the first side wall 22. The second forced air heating sub-system 26B is supported by and is generally disposed in the second side wall 24. The first and second forced air heating sub-systems 26A-B are generally identical (in particular are generally mirror images of one another). Accordingly, one forced air heating sub-system 26A will now be described with the understanding the description applies to the other forced air heating sub-system 26B.

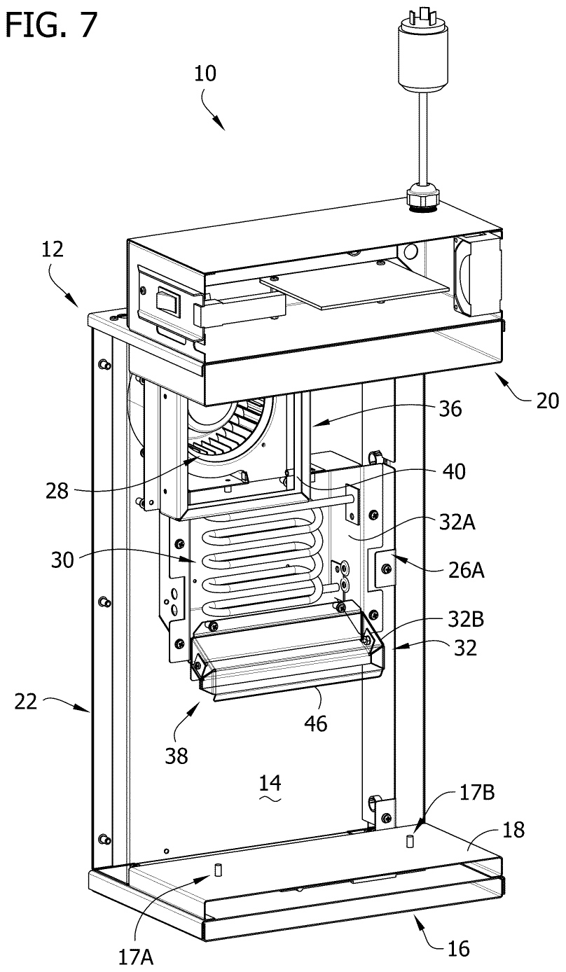

The forced air heating sub-system 26A includes a blower or fan 28 for blowing air and one or more heating elements 30 (e.g., electrical resistance heating elements) for heating the gas. In the illustrated embodiment, the heating element comprises an electrical resistance heating element with a plurality of U-shaped sections overlying one another (FIG. 7), although other shapes/configurations of heating elements may be used without departing from the scope of the present disclosure. The blower 28 and heating element 30 are disposed in the side wall 22, 24. The forced-air heating sub-system includes ductwork 32 (broadly, “ducting”). The ductwork 32 guides the heated gas from the forced air heating sub-system 26A-B to the food holder 80. The ductwork 32 defines gas passaging therein and extends along a side (e.g., first or second side) of the cabinet 12. Specifically, the ductwork 32 extends along a side wall 22, 24, with a portion of the ductwork being disposed in the side wall. The ductwork 32 includes (e.g., forms) one of the outlets 38. The blower 28 is disposed at an elevation above the outlet 38 and above the base 16. The heating element 30 is disposed in the ductwork 32 (in the air passaging), downstream of the blower 28. The heating element 30 heats the gas in the ductwork 32. The blower 28 blows the gas past the heating element 30 (which heats the gas as the gas passes) and through the ductwork 32.

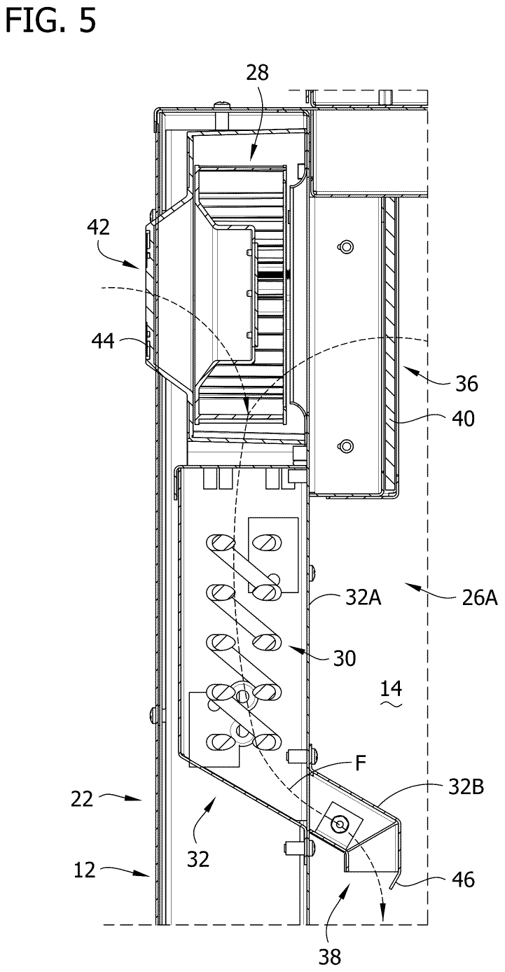

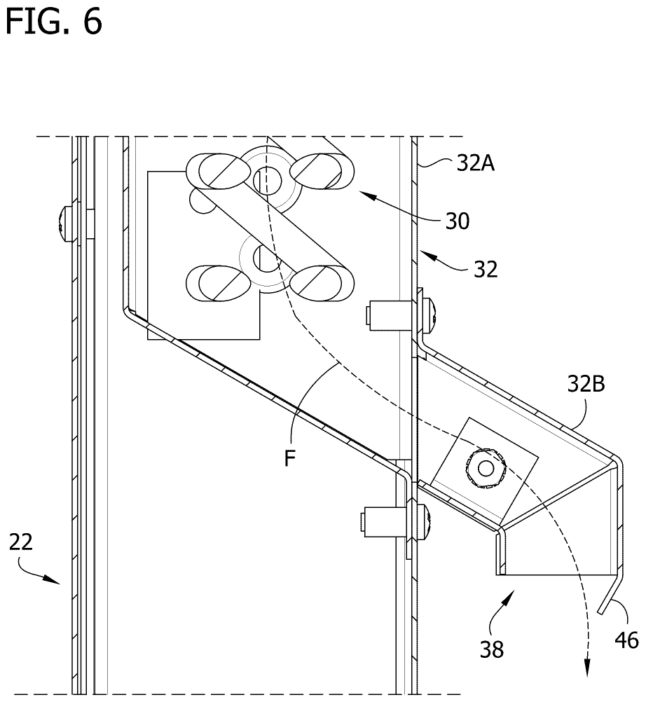

The blower 28 is arranged to draw gas from the food holder space 14. The sub-system 26A-B (broadly, the cabinet 12) includes a gas inlet 36 (e.g., a return gas inlet) in fluid communication (e.g., direct fluid communication) with the food holder space 14. The gas inlet permits the blower 28 to draw gas into the forced air heating sub-system 26A-B. In the illustrated embodiment, the gas inlet 36 is disposed in the food holder space 14. The gas inlet 36 is disposed at an elevation above the outlet 38 and above the base 16. The gas inlet 36 is disposed along a side (e.g., first or second side) of the food holder space 14. The sub-system 26A includes a filter 40 upstream of the blower 28 that filters the gas drawn by the blower, such as to remove oil or other debris that may be entrained in the gas from the food holder space 14. This prevents such oil and other debris from reaching the blower 28, prolonging the life of the blower. In the illustrated embodiment, the filter 40 is at (e.g., defines) the gas inlet 36. In other embodiments, the filter may be downstream of the gas inlet 36 (e.g., between the gas inlet and the blower). A representative gas flow F though the sub-system 26A is illustrated by the dashed lines in FIGS. 5 and 6. The blower 28 draws gas from the food holder space 14 through the gas inlet 36 and moves the gas in the ductwork 32 through the outlet 38 and back into the food holder space. In this manner, the sub-system 26A-B (broadly, the food holding unit 10) is able to recirculate the gas.

The sub-system 26A (broadly, the cabinet 12) may include a make-up gas inlet 42. The make-up gas inlet 42 is arranged to draw air from the surrounding environment outside the food holding unit 10. The make-up gas inlet 42 is in fluid communication (e.g., direct fluid communication) with the surrounding environment outside the cabinet. The blower 28 can draw make-up gas from the surrounding environment through the make-up gas inlet 42, to blow a mixture of non-recirculated and recirculated gas out the outlet 38. The sub-system 26A-B (broadly, the cabinet 12) may include a damper 44 for regulating the flow of the make-up gas. In the illustrated embodiment, the damper 44 is located at (e.g., defines) the make-up gas inlet 42. In other embodiments, the damper may be downstream of the make-up gas inlet. In one embodiment, the damper 44 has one or more openings adjustable in size by adjusting a position of a gate or door, although other configurations of the damper are within the scope of the present disclosure. The damper 44 may be placed in a closed configuration to block make-up gas from being drawn by the blower 28, a partially open configuration to permit some make-up gas to be drawn by the blower, or a fully open configuration to maximize the amount of make-up gas drawn by the blower. This allows an operator to regulate the amount of make-up gas that is taken in by the forced-air heating sub-system 26A-B. In the illustrated embodiment, the amount of openness of the damper 44 corresponds to the amount the make-up gas inlet is uncovered by the make-up gas gates/doors/valve members. The gas inlet 36 is disposed on the interior of the side wall 22, 24 and the make-up gas inlet 42 is disposed on the exterior of the side wall. The blower 28 draws air in from the food holder space 14 through the gas inlet 36 and may draw gas in from the surrounding environment through the make-up gas inlet 42 and pushes the gas through the ductwork 32 toward the outlet 38.

Referring to FIGS. 5 and 6, the ductwork 32 of the sub-system 26A includes a first or vertical duct section 32A that guides the air generally vertically downward from the blower 28 and a second or generally laterally protruding duct section 32B extending downward and inward. The heating element 30 is disposed in the vertical duct section 32A. The laterally protruding duct section 32B extends laterally from the side wall 22, 24 into the food holder space 14. In the illustrated embodiment, the laterally protruding duct section 2B includes the outlet 38. The outlet 32 is disposed inward of an interior surface of the side wall 22, 24 that bounds the food holder space 14.

The forced air heating sub-system 26A may include an air flow guide 46 to direct the heated gas from the outlet 38 toward food holder 80 (e.g., the inlet thereof). In the illustrated embodiment, the air flow guide 46 comprises a wall of the ductwork 32. The wall is disposed at an angle to vertical and to horizontal. The air flow guide 46 is disposed on the laterally inward side of the outlet 38 to prevent heated gas leaving the outlet from flowing generally inwardly (toward the center of the food holder space 14). The air flow guide 46 directs air flow downward to a side of the food holder space 14.

Referring to FIG. 4, the configuration of the forced air heating system (e.g., the forced air heating sub-systems 26A-B) creates recirculation of the heated gas. As shown by the representative gas flows F in FIG. 4, the gas is drawn through the gas inlets 36 from the food holder space 14 by the blowers 28, which forces the gas through the ductwork 32, past the heating elements 30, and out through the outlets 38 and into the food holder 80 (broadly, back into the food holder space). The gas then flows F through the food holder 80, thereby keeping the food warm, and into the upper portion of food holder space 14 (e.g., the portion of the food holder space above the food holders 80 and is unoccupied by the food holders). The cycle then starts again. This recirculation of the air increases the efficiency of the food holding unit 10 by being able to reheat already heated air. Recirculating and reheating previously heated gas reduces power consumption by reducing the power used by the heating elements 30. Further, if desired, the dampers 44 can be opened and make-up gas can also be drawn in from the surrounding environment to enter the recirculation.

Referring back to FIG. 1, the food holding unit 10 may include a control system 48 with controls 48A (e.g., “user interface” including on/off switch, temperature displays, temperature setting buttons, etc.) for controlling the operation of the food holding unit 10, specifically the forced air heating system. In the illustrated embodiment, the control system 48 is disposed above the food holder space 14. In other embodiments, the control system may be disposed below the food holder space. Other configurations of the control system may be used without departing from the scope of the present disclosure.

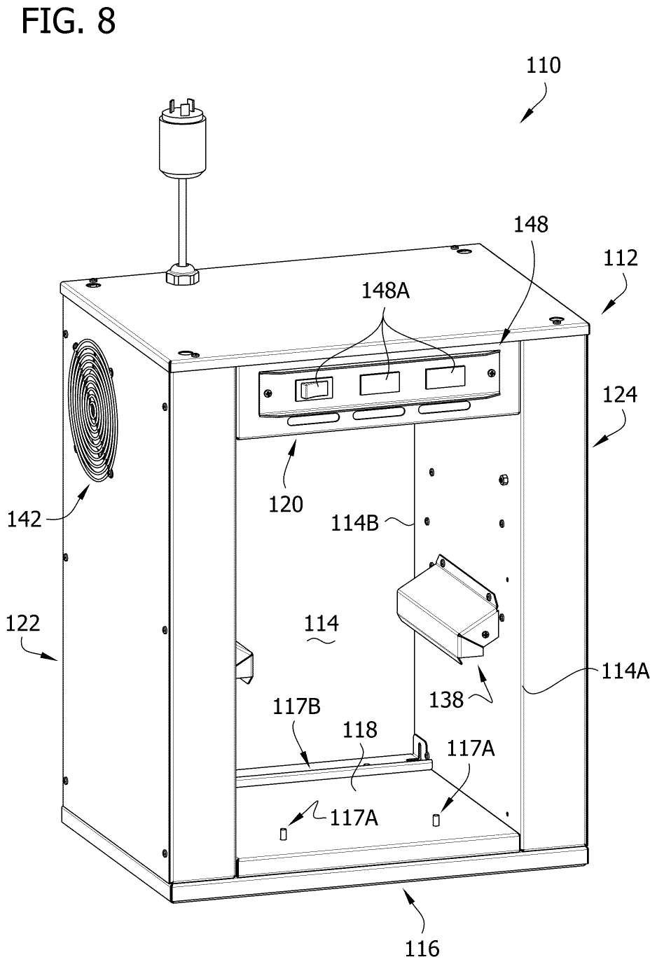

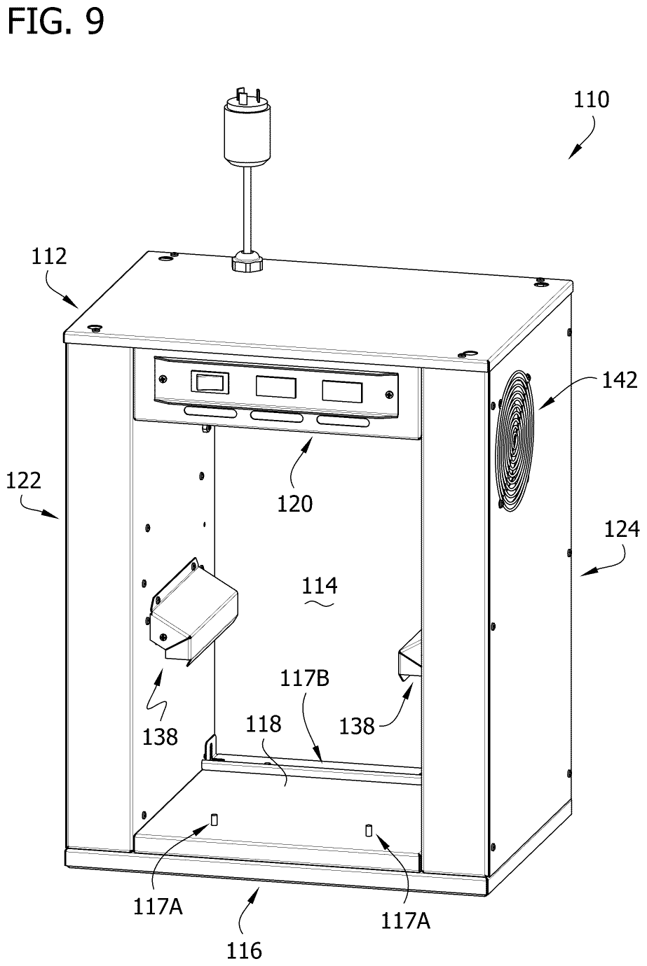

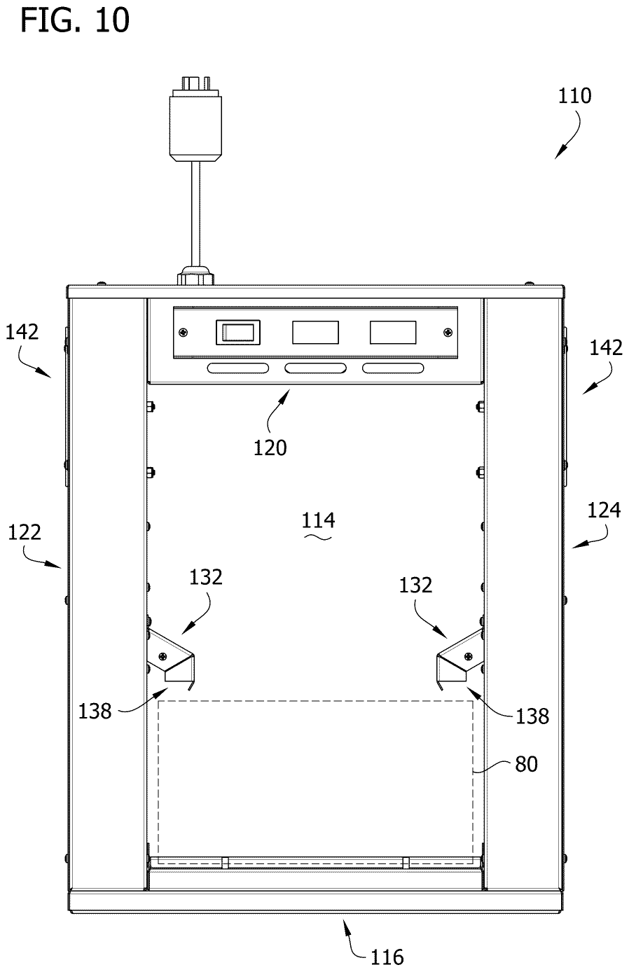

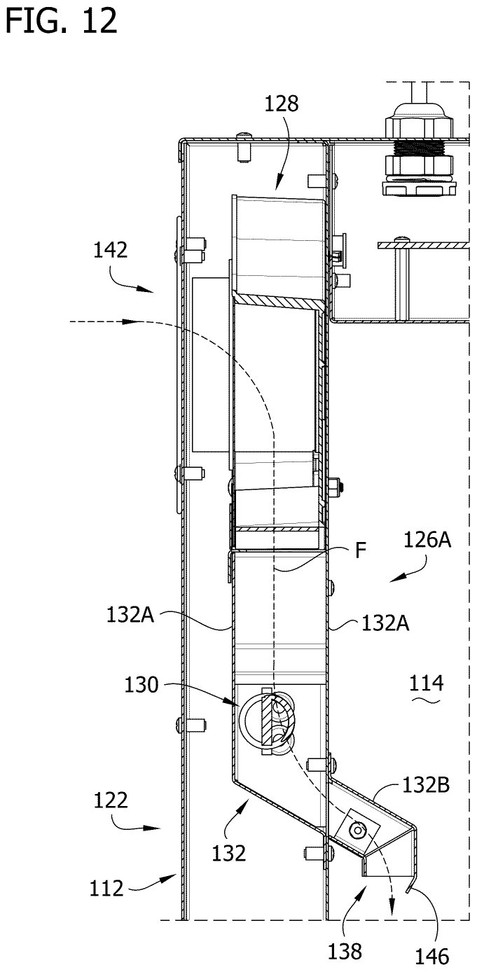

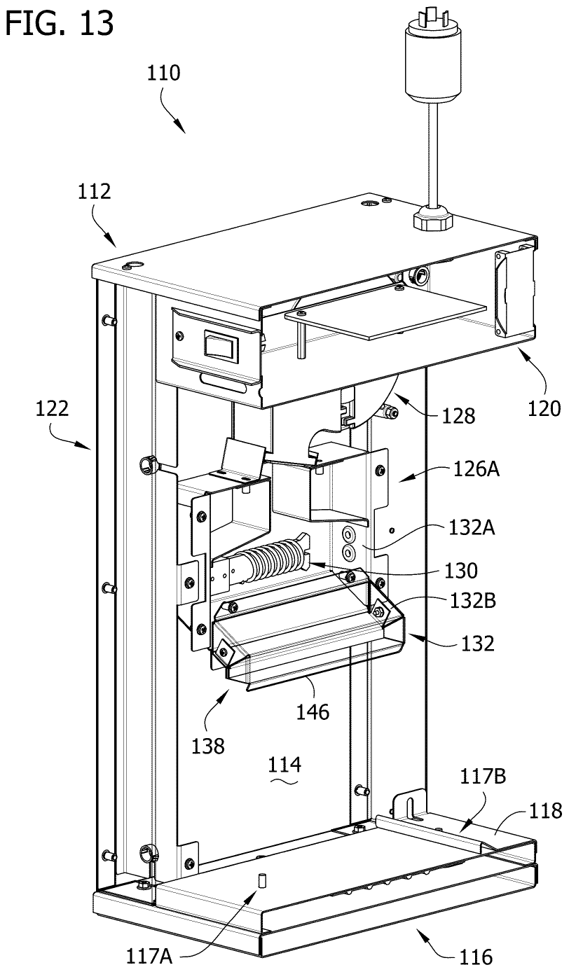

Referring to FIGS. 8-13, another embodiment of a food holding unit according to the present disclosure is generally indicated at reference numeral 110. The food holding unit 110 of FIGS. 8-13 is generally analogous to the food holding unit 10 of FIGS. 1-7 and, thus, for ease of comprehension, where similar, analogous or identical parts are used, the same reference numerals plus “100” are employed. Accordingly, unless clearly stated or indicated otherwise, the above descriptions regarding the food holding unit 10 of FIGS. 1-7 also apply to the food holding unit 110 of FIGS. 8-13.

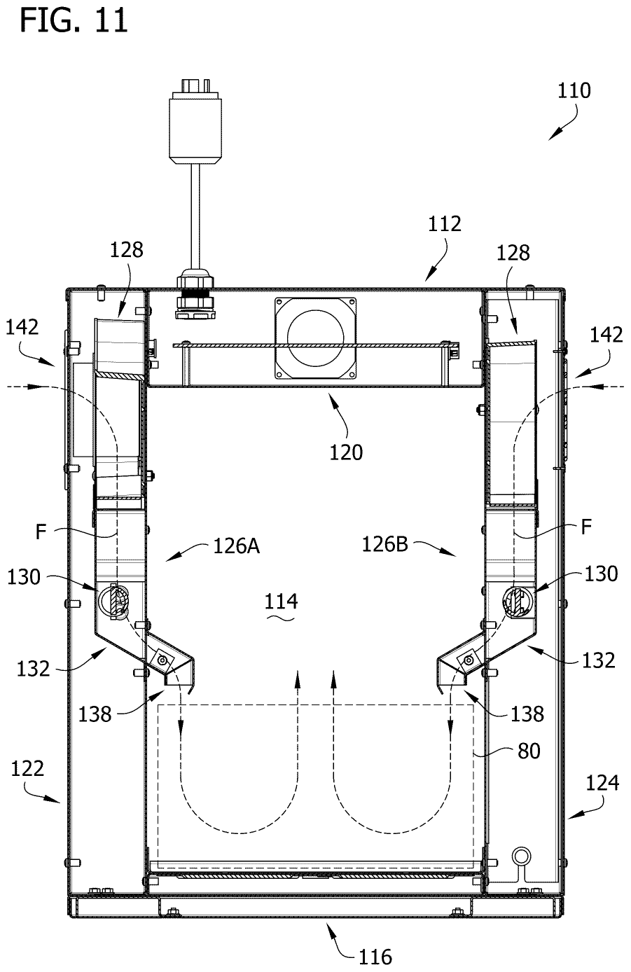

In this embodiment, the heated gas delivery system of the food holding unit 110 does not recirculate the gas. The cabinet 112 includes gas inlets 142 in fluid communication with the surrounding environment. But no return gas inlets are provided. Thus, the food holding unit 110 supplies only fresh air from the surrounding environment to the food holder 80. With reference to FIG. 11, fresh or clean gas is drawn through the gas inlets 142 by the blowers 128, out the outlets 138 and into the food holder 80. The gas flows F up out of the food holder 80 into the upper portion of the food holder space 114. The gas can then flow out of the food holder space 114 through the open front 114A and/or open back 114B. This arrangement may prolong the life of the blowers 128, because gas from the food holder space 114 entrained with oil and other debris does not come into contact with the blowers. In the illustrated embodiment, the food holding unit 110 does not include dampers. In addition, in this embodiment, the heating elements 30 have a coiled shape. Further, in this embodiment, the rear stop 117B comprises a ramp to facilitate insertion of the food support 80 in the food holder space 114 from the open back 114B. The ramp guides the food support 80 over the rear stop 117B when the food support is being inserted into the food holder space 114. In some embodiments, the front stop 117A may also comprise a ramp. It will be appreciated that other configurations can be used without departing from the scope of the present disclosure. For example, return gas inlets and/or louvers may be used.

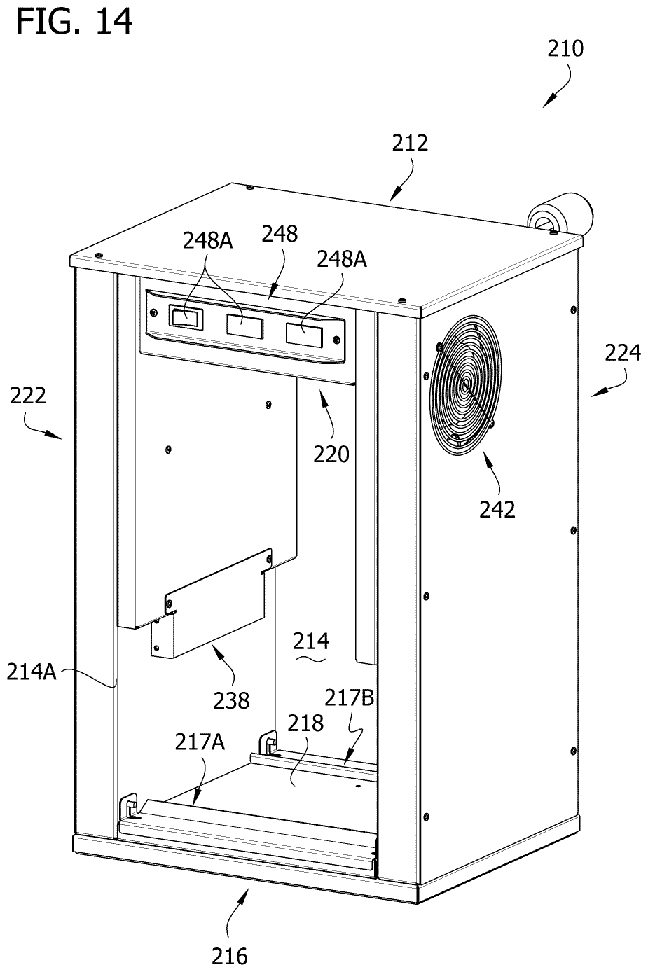

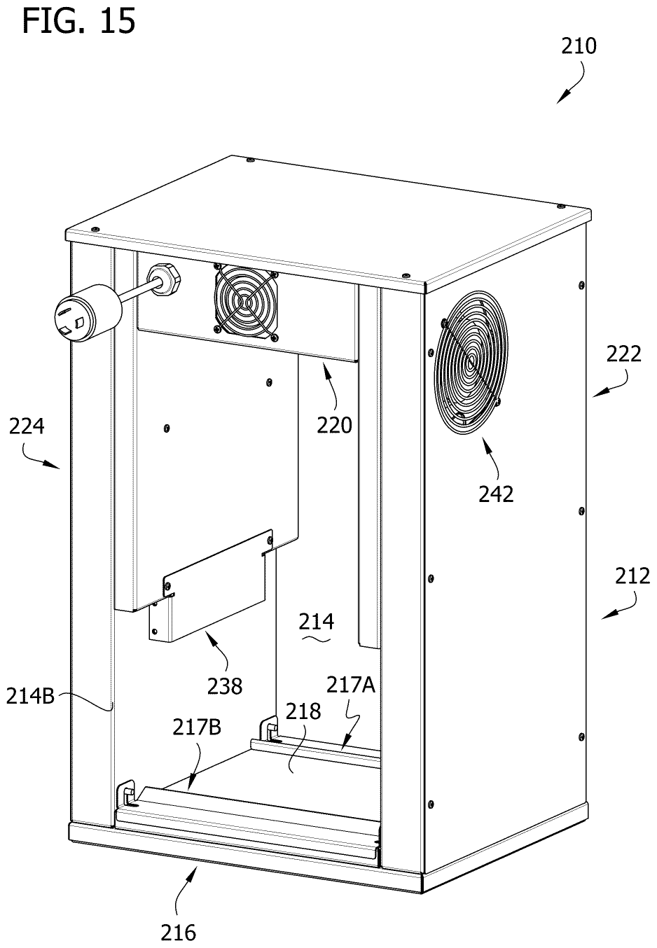

Referring to FIGS. 14-17, a food holding unit according to one embodiment of the present disclosure is generally indicated by reference numeral 210. The food holding unit 210 maintains cooked food at a proper temperature. The cooked food may be held by a food holder (shown schematically at reference numeral 80) that is in the food holding unit 210. The food holding unit 210 is configured for heating food with heated gas (e.g., air). For example, the food holding unit 210 may be referred to as a food warmer for maintaining cooked food held by the food holder 80 in a warm condition (broadly, proper serving temperature) before it is served. The food holding unit 210 may be used for heating various types of food, such as potato fries, onion rings, and other fried foods or non-fried foods. It will be appreciated that other types of food can be held (e.g., cooled food, or ambient temperature food) without departing from the scope of the present disclosure.

The food holding unit 210 includes a cabinet, generally indicated at 212. The cabinet 212 has a front and a back and opposite first and second sides. The cabinet 212 has (e.g., defines) a food holder space or interior 214 (broadly, food conditioning space or food holding space) that is sized and shaped to receive the food holder 80 (broadly, one or more food holders) containing the cooked food (broadly, the food holder space is sized and shaped to receive the food). The food holder space 214 of the cabinet 212 has an open front 214A. The open front 214A is in open communication (e.g., direct open fluid communication) with the surrounding environment outside the food holding unit 210. The open front 214A is sized and shaped to permit the food holder 80 to be inserted into and removed from the food holder space 214 through the open front and for a user to remove food from the holder while the holder is in the food holder space.

Desirably, the cabinet 212 is a pass-through cabinet. In the illustrated embodiment, the food holder space 214 of the cabinet 212 also has an open back 214B opposite the open front 214A. The open back 214B is in open communication (e.g., direct open communication) with the surrounding environment outside the food holding unit 210. The open back 214B is sized and shaped to permit the food holder 80 to be inserted into and removed from the food holder space 214 through the open back and for a user to remove food from the holder while the holder is in the food holder space. The open front 214A and the open back 214B of the food holder space 214 allow the food holder 80 to be inserted into and removed from the food holder space of the cabinet 212 from the front and/or back and to allow food to be inserted into and removed from the food holder from the front and/or back.

The cabinet 212 has a base 216 which includes a floor 218. The base 216 rests on a support surface, such as a countertop or tabletop. The floor 218 supports the food holder 80 when the food holder is disposed in the food holder space 214 of the cabinet 212. The removability of the food holder 80 makes it easier to (1) place and remove food from the food holder and (2) to clean the food holder (e.g., remove grease, food, and/or other debris). The floor 218 can be broadly referred to as a food holder support.

The food holding unit 210 is free of a door (e.g., front door) arranged to close the open front 214A of the food holder space 214 and is free of a door (e.g., back door) arranged to close the open back 214B of the food holder space. The absence of doors allows an operator or user to quickly insert the food holder 80 into and remove the food holder from the food holder space 214. Broadly, the food holding unit 210 is free of any structure that would need to be moved, either manually or automatically, to allow the food holder 80 to be inserted into and/or removed from the food holder space 214.

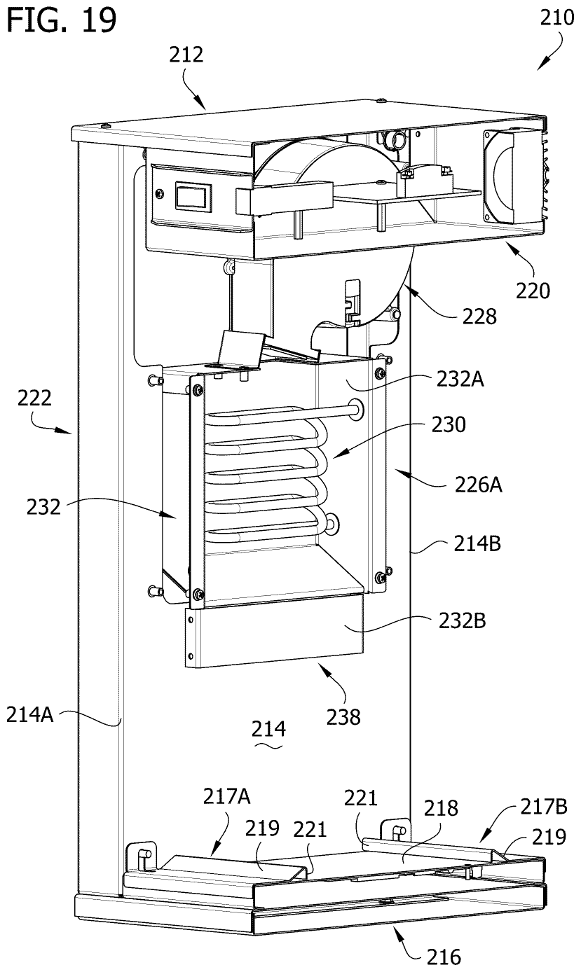

The floor 218 of the cabinet 212 bounds a bottom of the food holder space 214. Desirably, the floor 218 extends from the front to the back of the cabinet 212. The cabinet 212 includes a ceiling or top portion 220 that bounds a top of the food holder space 214. The cabinet 212 also includes a first side and a second side. The cabinet 212 includes opposite first and second side walls (e.g., left and right side walls) 222, 224 generally forming the respective first and second sides of the cabinet. The first side wall 222 bounds a first side of the food holder space 214 and the second side wall 224 bounds a second side of the food holder space. Desirably, the open front 214A and the open back 214B extend from the floor 218 to the ceiling 220 and from the first side wall 222 to the second side wall 224. This makes the open front 214A and open back 214B relatively large. The large size of the open front 214A and the open back 214B relative to the food holder 80 makes it easier to insert and remove the food holder into and from the food holder space 214 and to retrieve food while the holder is in the space. The base 216 is arranged to support the food (specifically, the food holder 80) between the first and second side walls 222, 224. In the illustrated embodiment, the base 216 includes a rear stop 217B and a front stop 217A for positioning the food holder 80 in the food holder space 214 (such as relative to the outlets 238 described herein). In the illustrated embodiment, the front and rear stops 217A-B are identical (e.g., mirror images of one another). Each stop 217A-B comprises a ramp 219 (FIG. 19) to facilitate insertion of the food support 80 in the food holder space 214 from the respective open front 214A and open back 214B. The ramp 219 guides the food support 80 over the stop 217A-B when the food support is being inserted into the food holder space 214. The stops 217A-B have generally vertical food holder stop surfaces 221 (FIG. 19) that face one another and engage the respective front and back of the food holder 80 to locate the food holder in the food holder space 214 (specifically, relative to the outlets 238). The stops 217A-B may be removable from the base 216 (broadly, the cabinet 212). In the illustrated embodiment, the stops 217A-B each include slots or openings that receive pins or projections for connecting the stop to the cabinet 212. The stops 217A-B may also include a flange or tab that engages a front or rear edge of the base 216 to inhibit the stops from moving relative to the base. Other configurations of the stops may be used without departing from the scope of the present disclosure.

The food holding unit 210 includes a forced air heating system (broadly, heated gas delivery system) for heating and moving gas about the cabinet 212. The forced air heating system moves the heated gas toward the food to be heated, thereby maintaining the cooked food at a proper temperature before serving. The forced air heating system includes one or more outlets (e.g., gas outlets) 238. In the illustrated embodiment, the forced air heating system includes two outlets 238. The outlets 238 deliver or direct the heated gas into the food holder space 214. Specifically, the outlets 238 are arranged to direct the gas into the food holder 80. The two outlets 238 are disposed on opposite sides of the food holder space 214. One outlet 238 is disposed along the first side of the food holder space 214 and the second outlet is disposed along the second side of the food holder space. In the illustrated embodiment, the outlets 238 are arranged to deliver or direct the heated gas in a downward (e.g., vertically downward direction) into the food holder space 214. In one embodiment, each outlet 238 is arranged to generally align with an inlet of the food holder 80 to direct the heated air toward and into the inlet of the food holder.

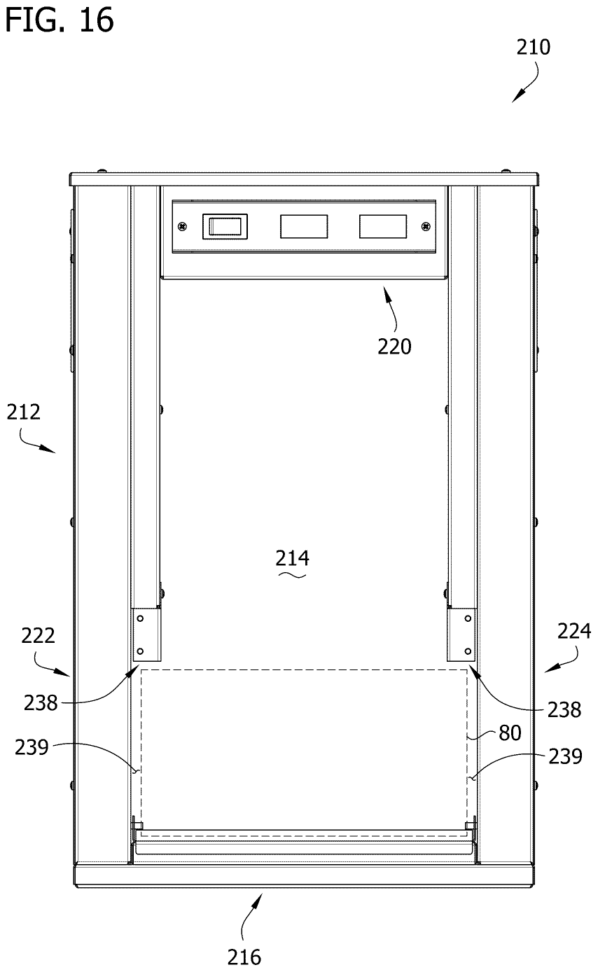

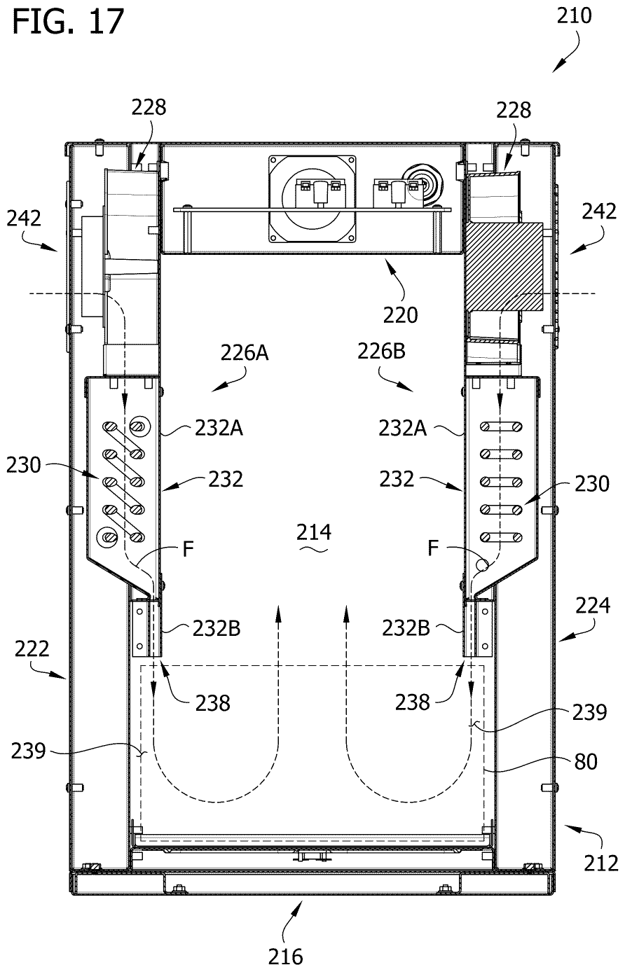

Each side wall 222, 224 defines a recess 239 (FIGS. 16 and 17) of the food holder space 214 in the inner, lower portion of the side wall. Each recess 239 extends upward from the base 216 (the floor 218) to generally the outlet 238. The recesses 239 are sized and shaped to permit the food holder 80 to extend into the recesses. The outlets 238 are arranged (e.g., are at the top of the recesses) to direct gas downward, into the recesses. In one embodiment, the width of the food holder space 214 (e.g., the distance between the first and second side walls 222, 224 at the recesses 239) is slightly greater (e.g., less than 2 inches greater, or less than 1 inch greater) than a corresponding width of the food holder 80. This facilitates locating the food holder 80 laterally (e.g., side-to-side) in the food holder space 214. In particular, this facilitates the positioning of the food holder 80 relative to the outlets 238. The arrangement of the outlets 238, recesses 239, and side walls 222, 224 creates a more streamlined, appeasing visual appearance. The outlets 238 are streamlined in the sense that they are not cantilevered (e.g., on an arm) protruding inward form the inside surface of the side wall. Further, having the recesses 239 in the side walls 222, 224 reduces the size (e.g., width) of the cabinet 212 for a given size of food holder 80.

With reference to FIGS. 17-19, the forced air heating system includes a first (left) forced air heating sub-system 226A and a second (right) forced air heating sub-system 226B. The first forced air heating sub-system 226A is supported by and is generally disposed in the first side wall 222. The second forced air heating sub-system 226B is supported by and is generally disposed in the second side wall 224. The first and second forced air heating sub-systems 226A-B are generally identical (in particular are generally mirror images of one another). Accordingly, one forced air heating sub-system 226A will now be described with the understanding the description applies to the other forced air heating sub-system 226B.

The forced air heating sub-system 226A includes a blower or fan 228 for blowing air and one or more heating elements 230 (e.g., electrical resistance heating elements) for heating the gas. In the illustrated embodiment, the heating element comprises an electrical resistance heating element with a plurality of U-shaped sections overlying one another (FIG. 19), although other shapes/configurations of heating elements may be used without departing from the scope of the present disclosure. The blower 228 and heating element 230 are disposed in the side wall 222, 224. The forced-air heating sub-system includes ductwork 232 (broadly, “ducting”). The ductwork 232 guides the heated gas from the forced air heating sub-system 226A-B to the food holder 80. The ductwork 232 defines gas passaging therein and extends along a side (e.g., first or second side) of the cabinet 212. Specifically, the ductwork 232 extends along a side wall 222, 224, with the ductwork being disposed in the side wall. The ductwork 232 includes (e.g., forms) one of the outlets 238. The blower 228 is disposed at an elevation above the outlet 238 and above the base 216. Specifically, the blower 228 is disposed vertically above the outlet 238. The heating element 230 is disposed in the ductwork 232 (in the air passaging), downstream of the blower 228. The heating element 230 heats the gas in the ductwork 232. The blower 228 blows the gas past the heating element 230 (which heat the gas as the gas passes) and through the ductwork 232. The blower 228 moves the gas in the ductwork 232 through the outlet 238 and into the food holder space 214.

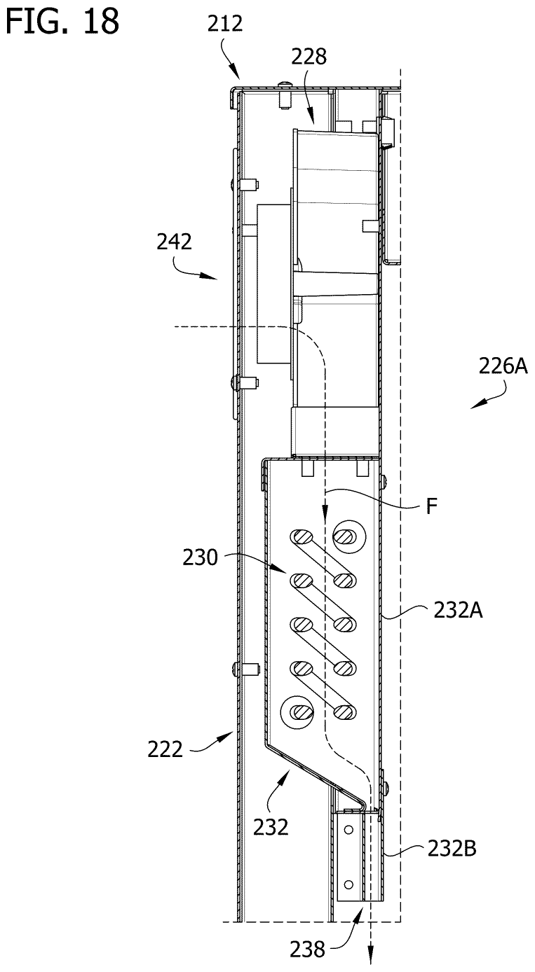

The sub-system 226A (broadly, the cabinet 212) includes a gas inlet 242. The gas inlet 242 is arranged to draw in air from the surrounding environment outside the food holding unit 210. The gas inlet 242 is in fluid communication (e.g., direct fluid communication) with the surrounding environment. The blower 228 draws gas (e.g., fresh air) from the surrounding environment through the gas inlet 242. The gas inlet 242 is disposed on the exterior of the side wall 222, 224. The gas inlet 242 is disposed at an elevation above the outlet 238 and above the base 216. A representative gas flow F though the sub-system 226A is illustrated by the dashed lines in FIGS. 17 and 18. The blower 228 draws gas in through the gas inlet 242 from the surrounding environment and pushes the gas through the ductwork 232 toward the outlet 238. The gas flows F out the outlet 238 and into the food holder space 214 (specifically, toward or into the food holder 80). The gas flows F up out of the food holder 80 into the upper portion of the food holder space 214. The gas can then flow out of the food holder space 214 through the open front 214A and/or open back 214B.

Still referring to FIGS. 17-19, the ductwork 232 of the sub-system 226A extends vertically downward from the blower 228 to the outlet 238. The ductwork 232 includes a first or vertical duct section 232A that guides the air generally vertically downward from the blower 228 toward the outlet 238. The heating element 230 is disposed in the vertical duct section 232A. The lower portion of the vertical duct section 232A is tapered (e.g., a tapered duct section) to narrow the ductwork to the size and shape of the outlet 238. The outlet 238 is defined by the bottom of the ductwork 232. The outlet 238 is disposed inboard of an interior-most surface of the side wall 222, 224 that bounds the food holding space 214 (specifically, an upper portion of the food holding space).

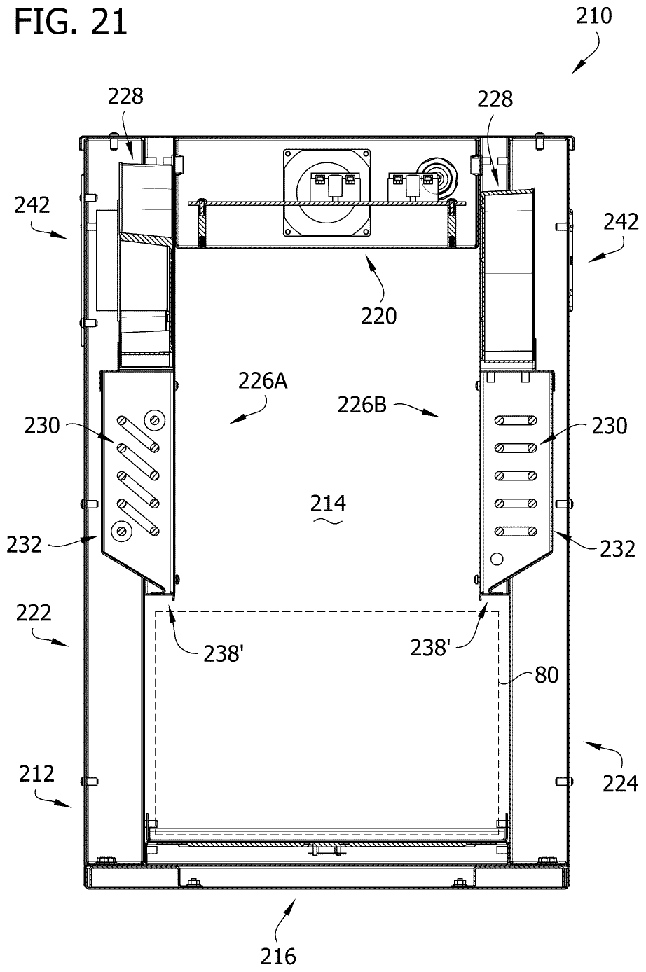

In the illustrated embodiment, the elevation of the outlet 238 (e.g., the distance between the floor 218 and the outlet) is adjustable. This allows the food holding unit 210 to be used with different food holders 80 of different heights (e.g., compare FIGS. 17 and 21). In the illustrated embodiment, the ductwork 232 is configured to adjust the elevation of the outlet 238. The ductwork 232 includes a removable duct section 232B for adjusting the elevation of the outlet 238. The removable duct section 232B may be secured to the side wall 222, 224 and/or vertical duct section 232A with one or more fasteners (e.g., bolts, screws, etc.). As shown in FIGS. 14-19, the removable duct section 232B defines (e.g., forms) the outlet 238 (e.g., a primary or first outlet).

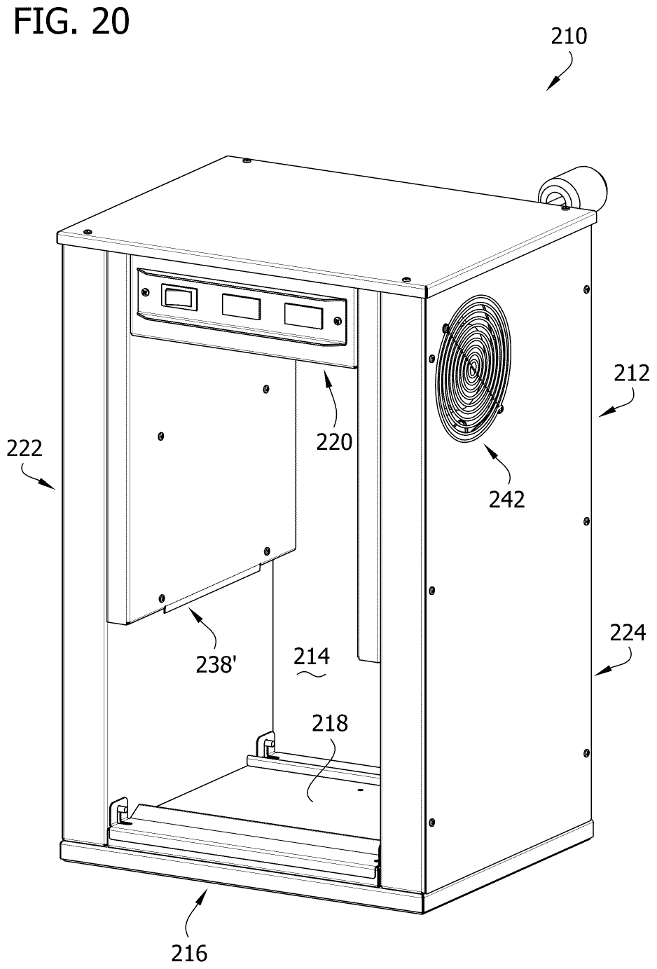

The removable duct section 232B forms the lower portion of the ductwork 232. As shown in FIGS. 20 and 21, when the removable duct section 232B is disconnected or removed, the removable duct section exposes another outlet 238′ (e.g., a secondary or second outlet) that is disposed at a higher elevation (broadly, changes the elevation of the outlet of the sub-system 226A-B). By selectively attaching/removing the removable duct section 232B, the user can configure the food holding unit 210 to have the outlet 238 at the desired elevation. Other ways of adjusting the elevation of the outlet 238 can be used without departing from the scope of the present disclosure. For example, the lower portion of the ductwork could telescope to raise and lower the outlet.

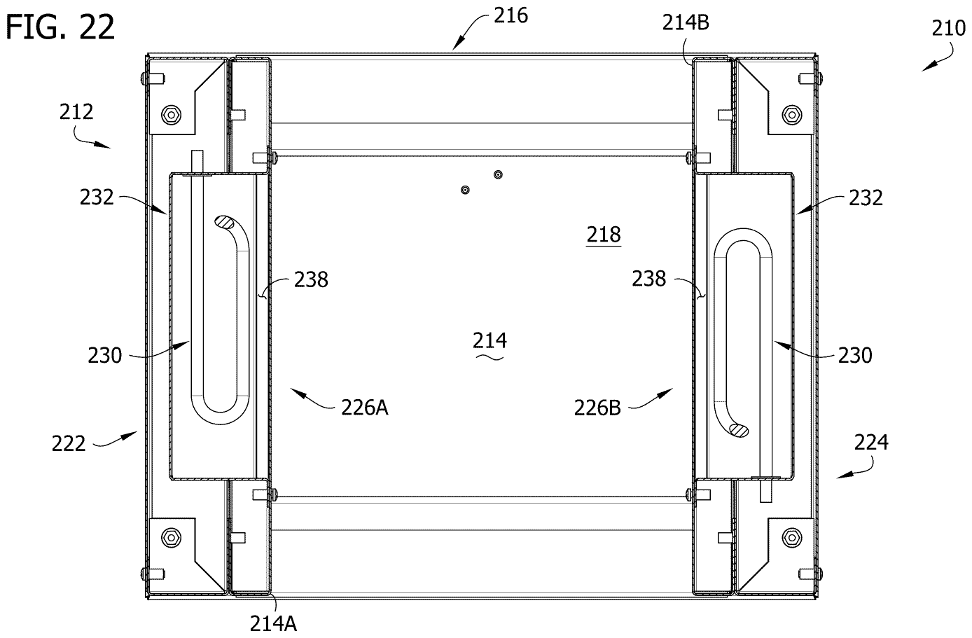

Referring to FIG. 22, the sub-system 226A is generally housed by or contained within the footprint of the side wall 222, 224. As shown, the outlet 238 is disposed within the footprint of the side wall 222, 224. In addition, the blower 228, the ductwork 232, and the heating element 230 are also disposed within the footprint of the side wall 222, 224. This arrangement of creates a more streamlined, appeasing visual appearance and also protects the outlets 238 from damage, such as by reducing the likelihood of inadvertent contact with a food holder 80 as the food holder is being moved in and out of the food holding space 214. The outlets 238 are not cantilevered (e.g., provided on an arm) into the food holding space 214.

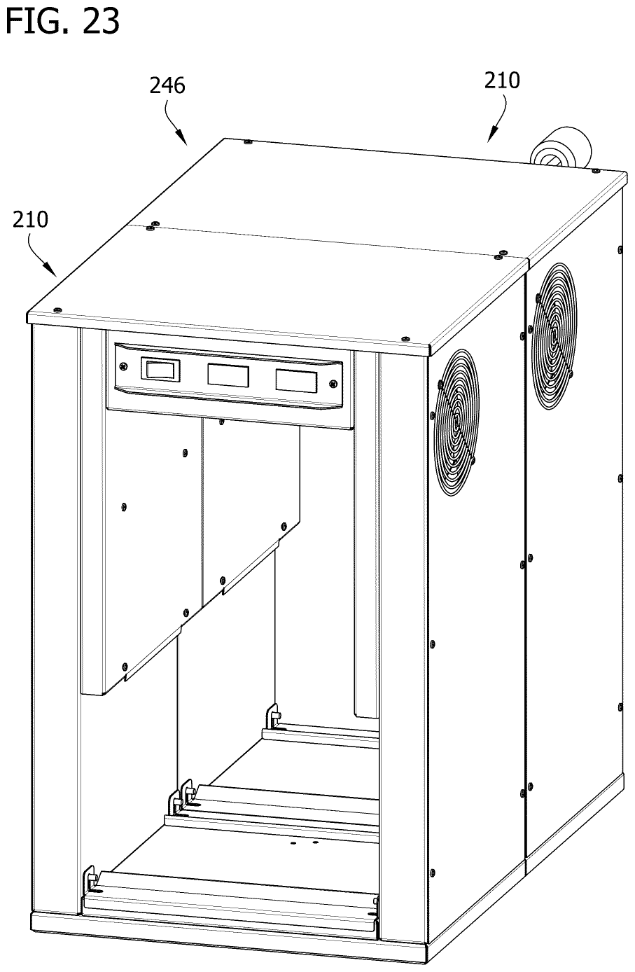

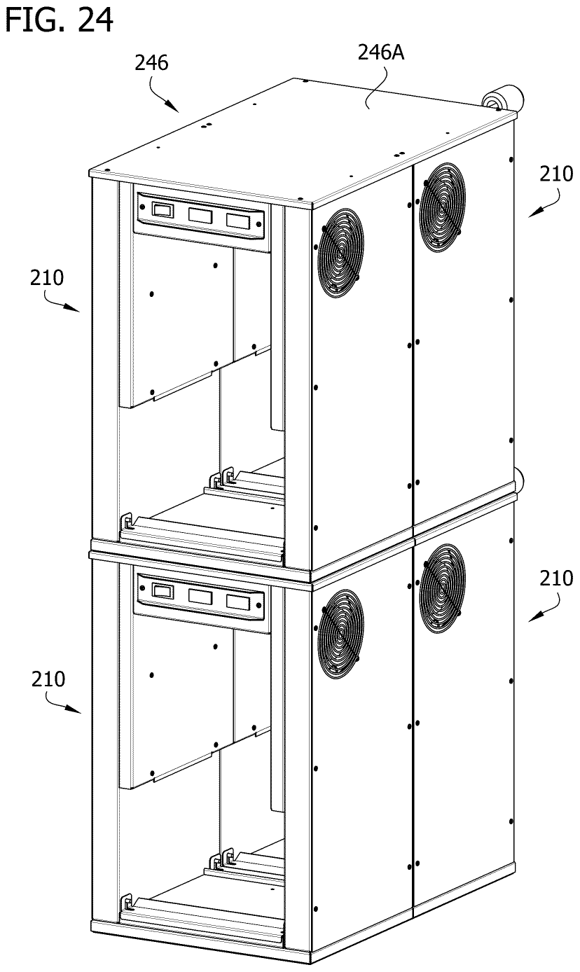

Referring to FIGS. 23 and 24, the food holding unit 210 is modular, thereby allowing the food holding unit to be combined with other food holding units to form a food holding unit assembly or food holding assembly 246. The food holding assembly 210 holds multiple food holders 80 and heats the food contained by the food holders. FIG. 23 shows a food holding assembly 246 with two food holding units 210 connected back-to-back for holding two food holders 80. FIG. 24 shows a food holding assembly 246 with four food holding units 210 connected in a 2×2 grid for holding four food holders 80. In this 2×2 arrangement, the lower two food holding units 210 are connected back-to-back and the upper two food holding units are connected back-to-back, with the upper two food holding units stacked on top of the lower two units. Because each food holding unit 210 is self-contained, the food holding units are generally plug and play. One food holding unit can be removed from the food holding assembly 246, without affecting the operation of the other food holding units. Further, the plug and play modular nature allows the food holding units 210 to be easily replaced, such as when one food holding unit breaks or needs to be taken down for maintenance. The food holding units 210 in the food holding assembly 246 can be secured together with a plurality of fasteners. In one embodiment, the food holding units 210 of the food holding assembly 246 may share common elements, such as a common top cover 246A as illustrated on the top two food holding units 210 in FIG. 24. Another common element may include a common base.

Referring back to FIG. 14, the food holding unit 210 may include a control system 248 with controls 248A (e.g., “user interface” including on/off switch, temperature displays, temperature setting buttons, etc.) for controlling the operation of the food holding unit 210, specifically the forced air heating system. In the illustrated embodiment, the control system 248 is disposed above the food holder space 214. In other embodiments, the control system may be disposed below the food holder space. Other configurations of the control system may be used without departing from the scope of the present disclosure.

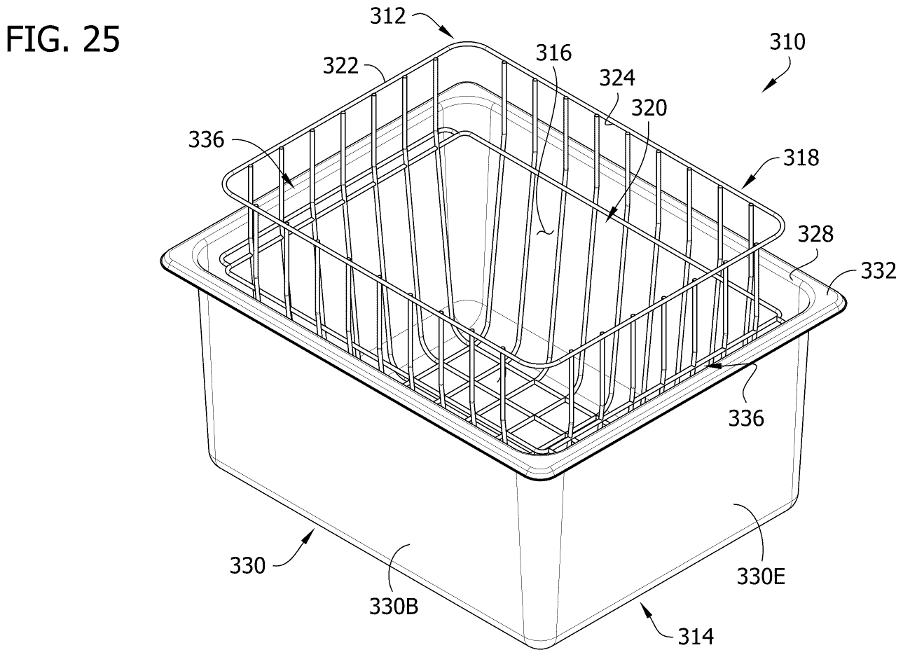

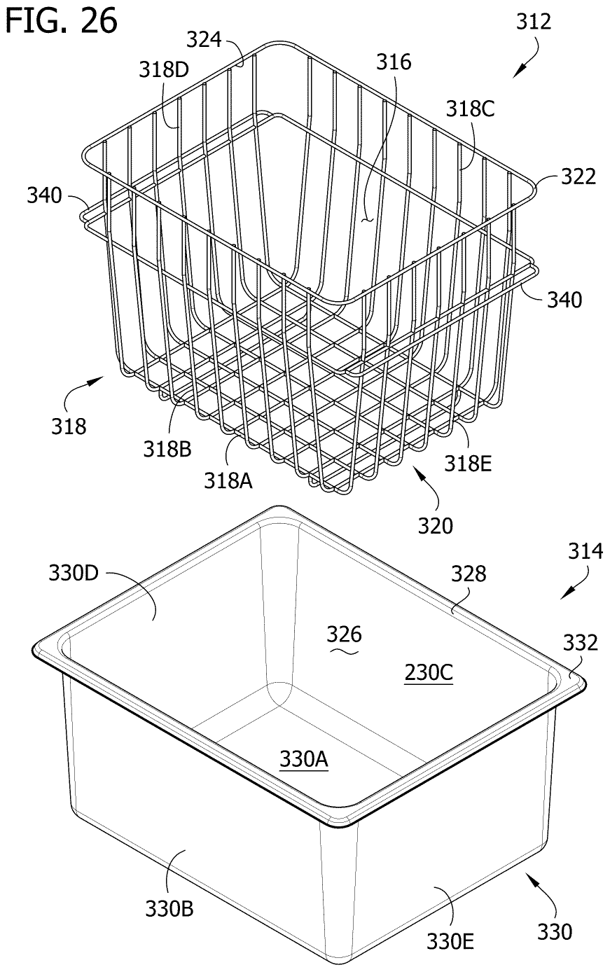

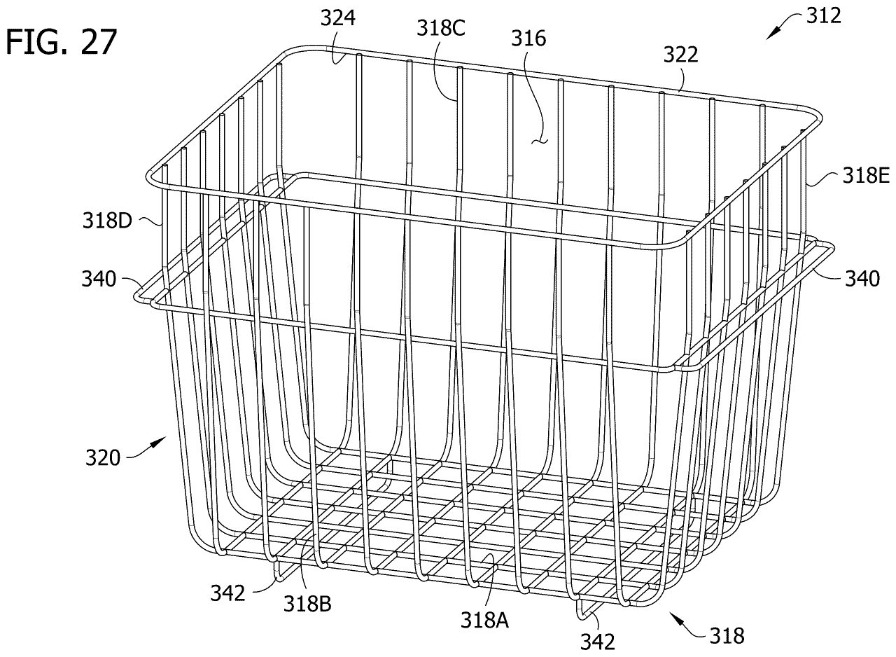

Referring to FIGS. 25-29, a food holder according to one embodiment of the present disclosure is generally indicated by reference numeral 310. The food holder 310 of FIGS. 25-29 is an example of a suitable food holder useable with a food holding unit disclosed herein, such as the food holding units 10, 110, 210. The food holder 310 holds cooked food in the food holding unit 10, 110, 210 and receives heated gas (e.g., air) from the food holding unit to keep the cooked food in a warm condition (broadly, proper serving temperature) before it is served. The food holder 310 may be used for holding various types of food, such as potato fries, onion rings, and other fried foods or non-fried foods. The food holder 310 includes a basket (broadly, food support) 312 and a grease collector or catch 314 (broadly, food container). The food support 312 is removably received by the food container 314. The food support 312 defines a food holding space 316. The food holding space 316 is sized and shaped to receive and hold the food. In the illustrated embodiment, the food holding space 316 is sized and shaped to hold about 30-36 pieces of fried chicken breasts, although other sizes may be used without departing from the scope of the present disclosure. The food support 312 includes a food support body 318 (e.g., a wire-formative body) having a bottom wall or floor 318A, opposite front and back side walls 318B, 318C extending upward from the bottom wall, and opposite left and right side walls 318D, 318E extending upward from the bottom wall. The front side wall, back side wall, left side wall, and right side wall may be referred to as upstanding food support body side walls. The bottom, front, back, left, and right side walls 318A-E bound the food holding space 316. In the illustrated embodiment, each of the front, back, left, and right side walls 318B-E includes a lower section or panel that tapers slightly outward as the section extends upward from the bottom wall 318A and an upper section or panel extending vertically upward from the top of the lower section. Each (broadly, one or more) of the bottom, front, back, left, and right side walls 318A-E includes a plurality of openings 320 (broadly, the food support 312 includes a plurality of openings, the plurality of openings being in one or more of the bottom, front, back, left, and/or right side walls). The openings 320 permit gas from outside the food support 312 to flow through the openings into the food holding space 316 of the food support. A rim 322 (e.g., a food support rim) of the food support 312 extends around the upper edges of the front, back, left, and right side walls 318B-E. In the illustrated embodiment, the upper edges of the front, back, left, and right side walls 318B-E form the rim 322. The rim 322 defines an open top of or food opening (mouth) 324 for the food holding space 316. The food opening 324 is at the upper end of the food holding space 316 and permits food to be inserted into and removed from the food holding space. In the illustrated embodiment, the food support 312 comprises a lattice structure or wire formative structure (e.g., a wire basket comprising a plurality of wire segments welded or otherwise suitably secured), although other configurations may be used without departing from the scope of the present disclosure. For example, the food support may have one or more sheet metal (e.g., perforated sheet metal) walls or segments and one or more wire formative walls or segments. In the illustrated embodiment, the lattice structure forms the openings 320 in the walls 18A-E of the food support 312. The food support 312 is free of any internal walls or partitions in the food holding space 316 for separating the cooked food held therein, thereby maximizing the amount of food that can be held in the food holding space. However, other configurations can be used without departing from the scope of the present disclosure.

The grease collector 314 catches and holds grease and other debris from the food that may drip or fall through the openings 320 in the food support 312. The grease collector 314 has a grease collector interior 326 (food container interior) sized and shaped to receive the food support 312. The grease collector interior 326 collects the grease. The grease collector 314 removably receives the food support 312 (broadly, the grease collector or food container is a food support holder). The grease collector includes a container opening 328 (at the upper end thereof) sized and shaped to allow the food support to be inserted into the grease collector (the interior thereof) and rest therein. The container opening 328 is an open top of the grease collector interior 326. The grease collector 314 includes a body 330 having a bottom wall or floor 330A, opposite front and back side walls 330B, 330C extending upward from the bottom wall, and opposite left and right side walls 330D, 330E extending upward from the bottom wall. The front side wall, back side wall, left side wall, and right side wall may be referred to as an upstanding side wall of the grease collector or food container. Each of the bottom, front, back, left, and right side walls 330A-E are solid (e.g., non-perforated) to hold grease and crumbs. The bottom, front, back, left, and right side walls 330A-E bound the grease collector interior 326. The grease collector 314 includes a rim (flange) 332 (e.g., grease collector rim) extending around the upper edges of the front, back, left, and right side walls 330B-D. The rim 332 defines the container opening 328. In the illustrated embodiment, the grease collector 314 has a generally planar bottom wall 330A. In other embodiments, the bottom wall may be arcuate and/or sloped, or include a plateau or other raised portion(s). Interior corners of the grease collector 314 may be rounded. This reduces the number of sharp corners making it easier to clean and improves airflow. In the illustrated embodiment, the grease collector 314 comprises a standard size food pan, such as a 6-inch deep food pan. For example, the grease collector 314 can be a 6-inch deep ½ size food pan or a 6-inch deep ⅔ size food pan. Other configurations of the grease collector may be used without departing from the scope of the present disclosure. For example, the grease collector may be an 8-inch deep food pan.

The food support 312 is sized and shaped to be disposed in the interior 326 of the grease collector 314 when the food support is removably received by the grease collector. In this position, the food support 312 is supported by the grease collector 314 and is removably disposed in the interior 326. In the illustrated embodiment, the food support 312 the bottom of the food support rests on the floor of the grease collector 314. The food holder 310 is free of any mechanical connection between the food support 312 and grease collector 314 that secures the two components together. This makes is easy to insert and remove the food support 312 from the grease collector 314, such as for cleaning, and simplifies manufacturing and construction. However, other configurations can be used without departing from the scope of the present disclosure. In the illustrated embodiment, with the food support 312 in the grease collector 314, the body 318 of the food support extends upward through the container opening 328 of the grease collector. Specifically, the front, back, left, and right side walls 318B-E of the food support 312 extend upward, through the container opening 328. Accordingly, the front, back, left, and right side walls 318B-E of the food support 312 extend upward past the respective upper ends of the front, back, left, and right side walls 330B-E of the grease collector 314. As a result, the food opening 324 of the food holding space 316 is disposed at an elevation above the container opening 328 of the grease collector interior 326. In other words, the food holding space 316 has a portion (e.g., upper portion) disposed at an elevation above the grease collector 314. The rim 322 of the food support 312 is disposed at an elevation that is higher than the rim 332 of the grease collector 314. For example, elevation distance between the rims 322, 332 is greater than 15% of the height of the grease collector 314, or greater than 20% of the height of the grease collector, or greater than 25% of the height of the grease collector, or greater than 30% of the height of the grease collector. In the illustrated embodiment, the grease collector 314 has a height of about 6 inches and the rim 322 of the food support 312 is at an elevation about 2 inches higher than the elevation of the rim 332 of the grease collector. Having the rim 322 of the food support 312 above the rim 332 of the grease collector 314 enlarges the volume of the food holding space 316 (compared to having the rims 322, 332 being substantially level with one another), thereby increasing the amount of food that can be held by the food holder 310. Other configurations (e.g., equal height food support and grease collector, or shorter height food support than grease collector) can be used without departing from the scope of the present disclosure.

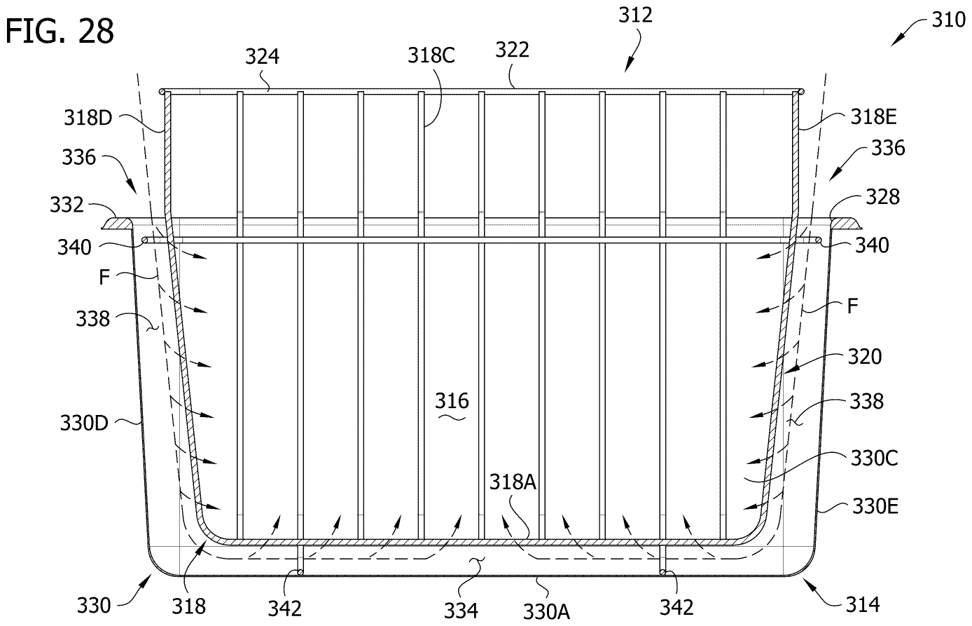

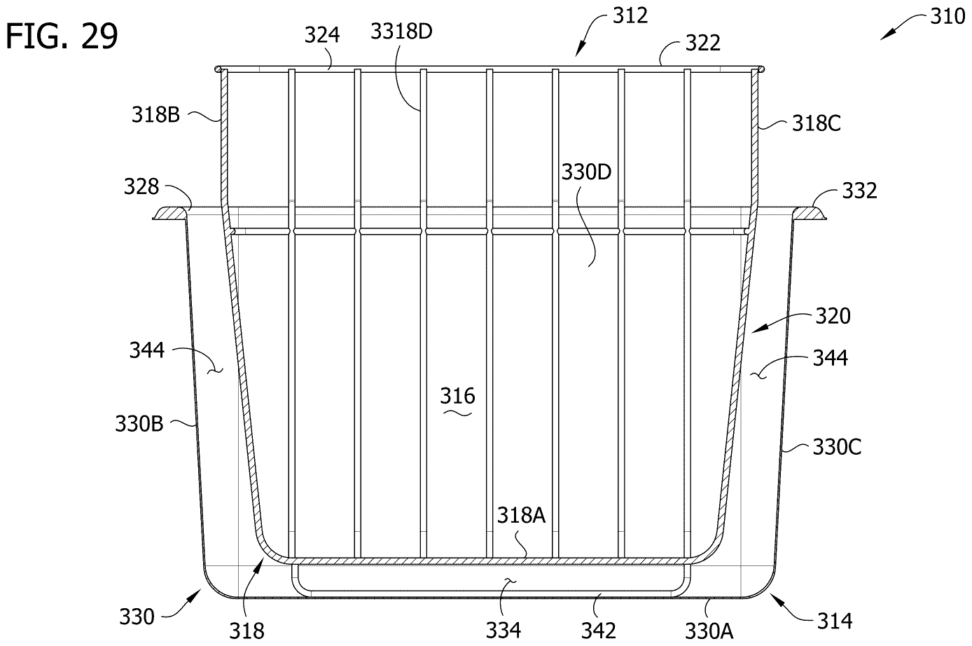

In one embodiment, the left and right sides of the rim 322 of the food support 312 are disposed inward of the left and right sides of the rim 332 of the grease collector 314 (see FIG. 28). In one embodiment, the front and back sides of the rim 322 of the food support 312 are vertically aligned with, outboard of, or inboard of the front and back sides of the rim 332 of the grease collector 314 (see FIG. 29). In the illustrated embodiment, the rim 322 of the food support 312 is above and inboard of the rim 332 of the grease collector 314.

The food holding unit 10, 110, 210 directs gas (e.g., heated air) into the food holder 310 to keep the food in the food holder warm. The food holder 310 receives the gas and directs the gas into contact with the food in the food holding space 316 to keep the food warm. In the illustrated embodiment, the food holder 310 is configured to introduce the gas from the food holding unit 10, 110, 210 into a bottom of the food holding space 316. This allows the heated gas to flow upward through the food holding space 316. The food holder 310 includes a gas supply plenum 334 disposed below and underlying the food holding space 316 (part of the grease collector interior 326 of the grease collector 314 is the gas supply plenum). The grease collector 314 and the food support 312 define the gas supply plenum 334. The bottom wall 330A of the grease collector 314 and the bottom wall 318A of the food support 312 are spaced apart from one another to form the gas supply plenum 334. The gas supply plenum 334 is in fluid communication with the food holding space 316. A bottom of the food holding space 316 and an upper portion of the gas supply plenum 334 are bounded (e.g., separated) by the bottom wall 318A of the food support 312, which has openings 320. The openings 320 fluidly couple the gas supply plenum 334 and the food holding space 316, thereby permitting gas from the gas supply plenum to flow upward through the openings into the food holding space (the bottom thereof).

The food holder 310 includes two gas inlets 336 (broadly, at least one gas inlet), one on the left side and one on the opposite right side of the food holder, that receive the heated air from the food holding unit 10, 110, 210 and permit the heated air to flow into the gas supply plenum 334. When the food holder 310 is in the food holding unit 10, 110, 210, the gas inlets 336 are directly below and in registration with the heated gas outlets for receiving heated gas from the food holding unit. The inlets 336 are fluidly connected to the gas supply plenum 334 such that the gas received by the inlets flows to the gas supply plenum (FIG. 28). The heated air then flows from the gas supply plenum 334, through the openings 320 in the bottom wall 318A of the food support 312, and into the food holding space 316 to heat the food therein. The heated air can also flow into the food holding space through the front, back, left, and right side walls 318B-E of the food support 312 via the openings 320 in those respective walls. It has been found that heating the food holding space 316 from the bottom creates a more even distribution of the heated air over the food holding space and therefore keeps all the food at a more uniform temperature. Representative gas flows F are illustrated by the dashed lines in FIG. 28. As illustrated, the inlets 336 are arranged to receive gas from the food holding unit 10, 110, 210 being directed downward into the food holder 310. The inlets 336 are defined by the grease collector 314 and the food support 312. The left side wall 330D of the grease collector 314 and the left side wall 318D of the food support 312 are spaced apart from one another to form the left or first inlet 336. The right side wall 330E of the grease collector 314 and the right side wall 318E of the food support 312 are spaced apart from one another to form the right or second inlet 336.

Together, the food support 312 and the grease collector 314 define the inlets 336, the gas supply plenum 334, and passageways 338 extending from the inlets to the gas supply plenum. The passageways 338 guide the heated air from the inlets 336 to the gas supply plenum 334. The food holder includes two passageways 338, one along the left side and one along the right side.

Each passageway 338 fluidly connects one of the inlets 336 to the gas supply plenum 334. The left side wall 330D of the grease collector 314 and the left side wall 318D of the food support 312 are spaced apart from one another to form the left or first passageway 338. The right side wall 330E of the grease collector 314 and the right side wall 318E of the food support 312 are spaced apart from one another to form the right or second passageway 338. The left passageway 338 delivers gas to the left side of the gas supply plenum 334 and the right passageway 338 delivers gas to the right side of the gas supply plenum. Therefore, as illustrated in FIG. 28, gas received by the left inlet 336 flows into a left side of the gas supply plenum 334 and gas received by the right inlet 336 flows into a right side of the gas supply plenum. These two gas flows F meet in the gas supply plenum 334, thereby forcing the gas to move or flow upward through the openings 320 in the bottom wall 318A of the food support 312 and into the food holding space 316. The openings 320 in the left and right side walls 318D, 318E of the food support 312 also fluidly connect the passageways 338 to the food holding space 316. This permits a portion of the gas flowing through the passageways 338 to flow through the openings 320 in these side walls 318D, 318E and into the food holding space 316 to heat the food in the food holding space. One or both of the passageways 338 together with the plenum 334 can be referred to broadly as food holder gas passaging.

The food holder 310 includes two spacers 340 (broadly, one or more spacers, or spacing structure) arranged to space the side walls 318D, 318E of the food support 312 from respective side walls 330D, 330E of the grease collector 314 to form the inlets 336 and the passageways 338. In the illustrated embodiment, the food support 312 includes the spacers 340. The food support 312 includes a left or first spacer 340 extending outward from the left side wall 318D of the food support that spaces the left side walls 318D, 330D apart to form the left side inlet 336 and passageway 338. Likewise, the food support 312 includes a second spacer 340 extending outward from the right side wall 318E of the food support that spaces the right side walls 318E, 330E apart to form the right side inlet 336 and passageway 338. The two spacers 340 are generally identical (e.g., are mirror images of one another). Each spacer 340 is configured to permit gas to flow past (e.g., through) the spacer. This allows the gas to flow along the passageway 338 from the inlet 336 to the gas supply plenum 334. Each spacer 340 includes an opening (broadly, at least one opening) that permits the gas to flow past the spacer from the inlet to the gas supply plenum 334. Each spacer 340 includes a spacer body, such as a wire-formative body, although other configurations may be used without departing from the scope of the present disclosure. The wire-formative body and the respective side wall 318D, 318E bound the opening of the spacer 340. In the illustrated embodiment, the wire-formative body includes a first or front segment, a second or back segment, and a third or intermediate segment. Each of the segments are generally linear. The first and second end segments are attached to and extend outward from the respective side wall 318D, 318E. The first and second end segments are connected to opposite ends of the intermediate segment by bends (e.g., about 90-degree bends). The intermediate segment is spaced apart from the respective side wall 318D, 318E, thereby permitting gas flow past the spacer 340 between the food support body and the spacer.

The food holder 310 also includes two lower spacers 342 (broadly, one or more lower spacers, or spacing structure) arranged to space the bottom wall 318A of the food support 312 from the bottom wall 330A of the grease collector 314 to form the gas supply plenum 334. In the illustrated embodiment, the food support 312 includes the lower spacers 342. The lower spacers 342 comprise feet extending downward from the bottom wall 318A of the food support 312 that rest on the bottom wall 330A of the grease collector 314 and space the bottom walls apart to form the gas supply plenum 334. The two lower spacers 342 are generally identical. Each lower spacer 342 is configured to permit gas to flow past (e.g., through) the spacer. This allows the gas to flow within the gas supply plenum 334 (from one section to anther). Each lower spacer 342 includes an opening (broadly, at least one opening) that permits the gas to flow past the spacer along the gas supply plenum 334. Each spacer 342 includes a spacer body, such as a wire-formative body, although other configurations may be used without departing from the scope of the present disclosure. The wire-formative body and the bottom wall 318A bound the opening of the spacer 342. In the illustrated embodiment, the wire-formative body includes a first or front segment, a second or back segment, and a third or intermediate segment. Each of the segments are generally linear. The first and second end segments are attached to and extend downward from the bottom wall 318A. The first and second end segments are connected to opposite ends of the intermediate segment by bends (e.g., about 90-degree bends). The intermediate segment is spaced apart from the bottom wall 318A, thereby permitting gas flow within the gas supply plenum 334 between the food support body and the spacer.

Other configurations (e.g., other numbers, sizes, shapes, etc.) of spacers (other spacing structure) can be used without departing from the scope of the present disclosure.

Moreover, it will be appreciated that one or more of the spacers (spacing structure) can be provided on the food container rather than the food support. For example, in one embodiment, the food container includes the spacing structure. In another embodiment, the food container includes some spacing structure, and the food support includes additional spacing structure. In yet another embodiment, the spacing structure is separate from the food container and food holder and useable with the food container and food holder.

Referring to FIG. 29, in the illustrated embodiment, the food holder 310 includes front and back passageways 344, in addition to the side passageways 338. The bottom of these passageways are in fluid communication with the gas supply plenum 334. The sides of the front and back passageways 344 may also be in fluid communication with the left and right side passageways 338. As a result, heated air enters the inlets 336 and can flow (via the side passageways 338 and/or gas supply plenum 334) into the front and back passageways 344. This results in a heated air curtain generally surrounding the food held in the food holding space 316, thereby keeping the food at a desired temperature while also reducing moisture build up in and around the food holding space, which would be detrimental to the texture of fried foods. Together, the food support 312 and the grease collector 314 define the front and back passageways 344. The front passageway 344 is generally defined by the front walls 318B, 330B of the food support 312 and the grease collector 314. Similarly, the back passageway 344 is generally defined by the back walls 318C, 330C of the food support 312 and the grease collector 314. The food support 312 may include front and back spacers (similar to the spacers described above but not shown) for spacing the front walls 318B, 330B and the rear walls 318C, 330C apart to form the respective front and back passageways 344. In one embodiment, the food holder 310 does not include front and back passageways. In such an embodiment, the front wall of the food support may be in close proximity to (e.g., engages) the front wall of the grease collector and the rear wall of the food support is in close proximity to (e.g., engages) the rear wall of the grease collector.

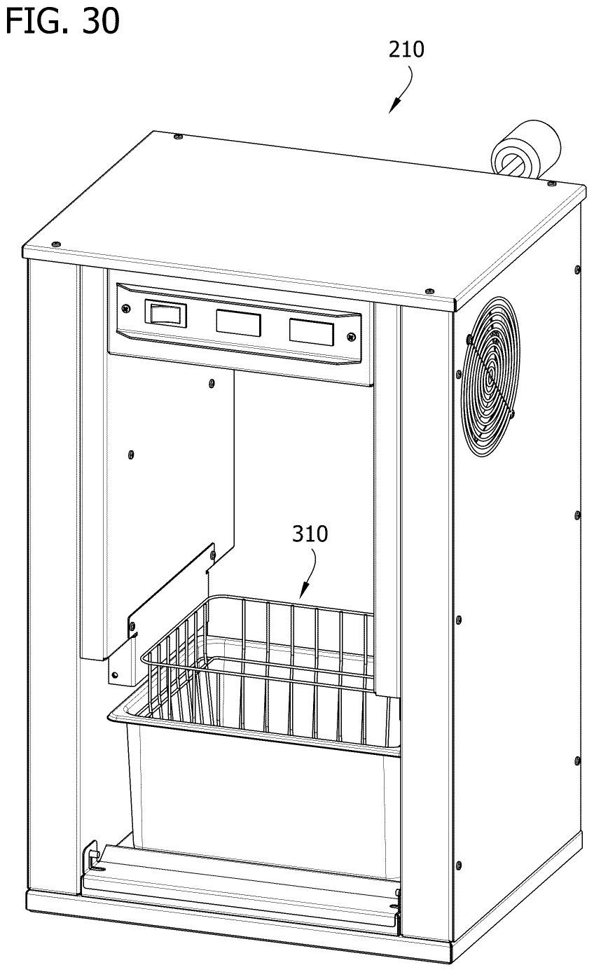

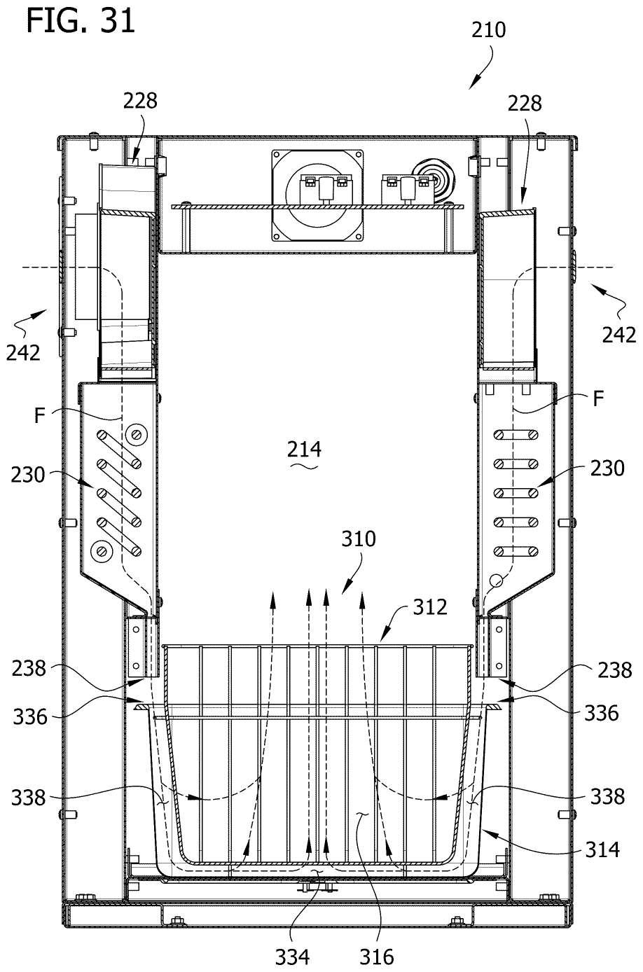

FIGS. 30 and 31 illustrate one embodiment of a food holding system comprising the food holding unit 210 of FIGS. 14-22 and the food holder 310 of FIGS. 25-29. Representative gas flows F for the food holding system are illustrated by the dashed lines in FIG. 31. After the food holder 310 containing food has been installed in the food holder space, the heated gas distribution and recirculation system is used to heat the food. The blowers 228 draw gas in through the respective gas inlets 242 from the surrounding environment and push the gas out the outlets 238, toward the food holder 310. The two gas flows F pass through their respective inlets 336 of the food holder 310, flow along the passageways 338, and into the gas supply plenum 334. These two gas flows F meet in the gas supply plenum 334, thereby forcing the gas to move upward into the food holding space 316. In addition, as each gas flow F flows along the passageways 338, a portion of the gas flow may enter the food holding space 316 via the openings 320 in the side walls 318D, 318E of the food support 312. The gas moves generally upward through the food holding space 216, heating the food contained therein. The gas can then flow out of the food holder space 214 through the open front 214A and/or open back 214B. (It will be understood that in other embodiments (e.g., FIG. 4), gas flowing upward from the food holder can be recirculated for further heating of the food.) In the embodiment of FIGS. 30 and 31, because the grease collector 314 of the food holder 310 comprises a 6-inch food pan, the removable duct sections 232B remain secured to the side wall 222, 224 so that the outlets 238 of the food holding unit 210 are positioned near the inlets 336 of the food holder to direct gas into the inlets. In another configuration with a taller grease collector 314 of the food holder 310 (e.g., the grease collector comprising an 8-inch food pan), the removable duct sections 232B would be removed to move the outlets 238 of the food holding unit 210 upward to compensate for the taller grease collector.

It is apparent and understood that the elements, features, and/or teachings set forth in each embodiment disclosed herein are not limited to the specific embodiment(s) the elements, features, and/or teachings are described in. Accordingly, it is apparent and understood that the elements, features, and/or teachings described in one embodiment may be applied to one or more of the other embodiments disclosed herein. For example, the food holding unit 210 of FIGS. 14-22 can include the gas inlets 36 of the food holding unit 10 of FIGS. 1-7 in order to recirculate the gas.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the present disclosure are achieved and other advantageous results attained.

As various changes could be made in the above constructions and methods without departing from the scope of the present disclosure, it is intended that all matter contained in the above description and shown in the accompanying drawings shall be interpreted as illustrative and not in a limiting sense.

1. A food holding system comprising:
a food holder including a bottom wall and a first upstanding wall, the food holder including a food support surface above the bottom wall, the food support surface having openings therein, the food support surface bounding a food holding space, the food holder defining a gas passageway between the food holding space and the first upstanding wall and defining a gas supply plenum between the food holding space and the bottom wall, the gas supply plenum being in fluid communication with the gas passageway, and the food holding space being in fluid communication with the gas supply plenum via the openings in the food support surface; and
a food holding unit defining a food holder space sized and shaped to receive the food holder, the food holder space having a food holder opening sized and shaped to permit the food holder to be inserted into and removed from the food holder space through the food holder opening, the food holder space being in open communication with a surrounding environment outside the food holding unit via the food holder opening, the food holding unit including a heated gas delivery system including a heated gas outlet configured to emit heated gas into the food holder space, the heated gas outlet being configured to, when the food holder is in the food holder space, direct heated gas from the heated gas outlet to flow downward in the gas passageway of the food holder to the gas supply plenum to move upward through the openings of the food support surface into the food holding space to heat food therein.

2-3. (canceled)

4. The food holding system of claim 1, wherein the food holder includes a floor, the floor defining the food support surface, the gas supply plenum being bounded by the floor and the bottom wall.

5-9. (canceled)

10. The food holding system of claim 1, wherein the food holder comprises a food support and a food container, the food support being removably receivable in the food container, the food support comprising the food support surface, and the food support including a first side wall bounding the gas passageway.

11. The food holding system of claim 1, wherein the heated gas delivery system includes a side duct section located laterally from the food holder space, the side duct section being in fluid communication with the heated gas outlet, the heated gas delivery system comprising a heater in the side duct section upstream of the heated gas outlet.

12-15. (canceled)

16. The food holding system of claim 1, wherein the heated gas delivery system comprises a gas inlet above the food holder space configured to receive gas from the food holder space to be recirculated by the gas delivery system back to the food holder space.

17. The food holding system of claim 1, wherein the food holding unit is free of a door arranged to close the food holder opening.

18. The food holding system of claim 1, wherein the food holder opening is a first food holder opening on a front side of the food holding unit, and the food holding unit includes a second food holder opening on a back side of the food holding unit, the second food holder opening being sized and shaped to permit the food holder to be inserted into and removed from the food holder space through the second food holder opening, the food holder space being in open communication with the surrounding environment outside the food holding unit via the food holder opening.

19. (canceled)

20. A method of holding food, the method comprising:
placing food in a food holding space of a food holder;
installing the food holder in a food holder space of a food holding unit;
operating a heated gas delivery system of the food holding unit to heat gas and to direct the heated gas downward from a first heated gas outlet of the food holding unit into a first gas passage of the food holder;
permitting the heated gas to flow downward along the first gas passage between the food holding space and a first upstanding wall of the food holder;
after permitting the heated gas to flow downward along the first gas passage, permitting the heated gas to flow in a gas supply plenum underlying the food holding space; and
after permitting the heated gas to flow in the gas supply plenum, permitting the heated gas to flow upward into the food holding space to heat the food in the food holding space.

21. The method of claim 20, wherein permitting the heated gas to flow downward along the gas passage comprises permitting the heated gas to flow downward between a first side wall of the food holder and the first upstanding wall of the food holder.

22. The method of claim 20, wherein permitting the heated gas to flow in the gas supply plenum underlying the food holding space comprises permitting the gas to flow between a bottom wall of the food holder and a food support surface bounding a bottom of the food support surface.

23. The method of claim 20, wherein permitting the heated gas to flow upward into the food holding space comprises permitting the heated gas to flow upward through openings of a food support surface supporting the food.

24-26. (canceled)

27. The method of claim 20, further comprising forming the gas supply plenum by removably installing a food support of the food holder in a food container of the food holder, the food support defining a food support surface for supporting the food in the food holding space.

28. The method of claim 27, wherein forming the gas supply plenum comprises spacing a floor of the food support from a bottom wall of the food support by positioning spacing structure between the floor and the bottom wall.

29-35. (canceled)

36. The method of claim 20, wherein installing the food holder in the food holder space comprises moving the food holder into the food holder space via a food holder opening of the food holding unit by which the food holder space is open to a surrounding environment outside the food holding unit.

37-71. (canceled)

72. A food holding unit for maintaining cooked food at a proper temperature, the food holding unit comprising:
a food container comprising at least a bottom wall;
a food support being removably receivable in the food container and comprising a food support surface spaced from the bottom wall of the food container when the food support is received therein to define a plenum therebetween;
a cabinet having a front and a back, the cabinet having opposite first and second sides, the cabinet having a food holder space sized and shaped to receive the food container, the food holder space having an open front in open communication with a surrounding environment outside the food holding unit, the open front being sized and shaped to permit the food container to be inserted into and removed from the food holder space through the open front;
ductwork extending along the first side of the cabinet, the ductwork including an outlet arranged to direct gas downward into the food container and into the plenum;
a heating element disposed in the ductwork for heating gas in the ductwork; and
a blower disposed at an elevation above the outlet, the blower being configured to emit gas from the blower downward to move gas in the ductwork through the outlet.

73. (canceled)

74. The food holding unit of claim 72, wherein the cabinet includes a side wall forming the first side of the cabinet, the side wall bounding a side of the food holder space, the outlet being disposed within a footprint of the side wall.

75. (canceled)

76. The food holding unit of claim 74, wherein the blower, the ductwork, and the heating element are disposed within the footprint of the side wall.

77. (canceled)

78. The food holding unit of claim 72, wherein the ductwork is first ductwork, the outlet is a first outlet, the heating element is a first heating element, and the blower is a first blower, and wherein the food holding unit further comprises:
second ductwork extending along the second side of the cabinet, the second ductwork including a second outlet arranged to direct gas downward into the food container and into the plenum;
a second heating element disposed in the second ductwork for heating gas in the second ductwork; and
a second blower disposed at an elevation above the second outlet, the second blower being configured to move gas in the second ductwork through the second outlet.

79-84. (canceled)

85. The food holding unit of claim 72, wherein the cabinet has a gas inlet in fluid communication with the surrounding environment outside the food holding unit, the blower being configured to draw gas from the surrounding environment through the gas inlet.

86. The food holding unit of claim 72, wherein the cabinet includes a floor and a ceiling, the floor being configured to support the food container when the food container is disposed in the food holder space, the floor bounding the bottom of the food holder space, the ceiling bounding a top of the food holder space.

87-89. (canceled)

90. The food holding unit of claim 72, wherein the food holder space has an open back opposite the open front, the open back being in open communication with the surrounding environment outside the food holding unit, the open back of the food holder space being sized and shaped to permit the food container to be inserted into and removed from the food holder space through the open back.

91. The food holding unit of claim 90, wherein the food holding unit is free of a door arranged to close the open back of the food holder space, and wherein the food holding unit is free of a door arranged to close the open front of the food holder space.

92. The food holding unit of claim 72 wherein the food container comprises a pan.

93. The food holding unit of claim 72 wherein the food support comprises a basket.
